(19) United States
(12) Patent Application Publication
(10) Pub. No.: US 2019/0079525 A1
(43) Pub. Date: Mar. 14, 2019

(54) AUTONOMOUS VEHICLE SUPPORT FOR SECONDARY VEHICLE

(71) Applicant: QUALCOMM Incorporated, San Diego, CA (US)

(72) Inventors: Regan Blythe Towal, San Diego, CA (US); Anne Katrin Konertz, Encinitas, CA (US); Jeremiah Golston, San Diego, CA (US)

(21) Appl. No.: 15/700,568

(22) Filed: Sep. 11, 2017

(51) Int. Cl. G05D 1/02; G05D 1/00; G06K 9/00; G06K 9/78

(52) U.S. Cl. CPC G05D 1/0214; G05D 1/0088; G05D 1/0055; G05D 1/0289; G05D 2201/0212; G06K 9/00335; G06K 9/78; G06K 9/00845; G05D 1/0285

(57) ABSTRACT

In general, techniques are described by which a first vehicle may provide support services for a second vehicle. A first vehicle, including a memory and a processor, may be configured to perform the techniques. The memory may be configured to store vehicle information relating to a second vehicle, the second vehicle configured to be operated by an operator. The processor may be configured to autonomously control positioning, based on the vehicle information, the first vehicle at a location relative to the second vehicle, and perform, after reaching the location, at least one service for the second vehicle.

### TECHNICAL FIELD

This disclosure relates to autonomous vehicles and, more specifically, autonomous vehicle support for a secondary vehicle.

### BACKGROUND

A commuter traveling from a first location to a second location may choose to operate a first vehicle (e.g., a motorized vehicle) or a second vehicle (e.g., a non-motorized vehicle, such as a bicycle). Given that both of the first and second vehicles must be manually operated, the commuter (which may also be referred to as the “operator”) may select which of the first or second vehicles to operate. The motorized vehicle may provide some benefits in terms of convenience (e.g., being operational in most types of weather, offering amenities such as air conditioning, heat, etc.), speed of travel (in good traffic conditions), and extensive safety measures (compared to bicycles), but lack other benefits, such as providing opportunities for exercise. The bicycle may provide benefits the motor vehicle lacks, such as providing exercise, but lack the benefits provided by the motor vehicle, such as convenience, speed of travel (in good traffic conditions), and extensive safety measures.

The commuter often selects which of the first and second vehicles to operate while traveling to the second location based on the operational context while travelling between the first and second locations. The operational context may, for example, include one or more of a distance between the first and second destination, expected weather conditions while traveling, traffic conditions of the route used to travel between the first and second locations, etc. The ability to only operate one of the first and second vehicles may potentially deprive the commuter of at least some benefits of traveling by way of the unselected first or second vehicle. Furthermore, the operational context may unexpectedly change (e.g., the weather condition may change) while traveling to the second location such that the original choice of vehicle would not have been selected given the new unexpected operational choice, further depriving the commuter of potential benefits of the unselected first or second vehicle.

### SUMMARY

In general, this disclosure describes techniques for allowing an operator to experience the benefits of travel by way of both a first vehicle (e.g., a motorized vehicle) and a second vehicle (e.g., a non-motorized vehicle, such as a bicycle). The techniques may take advantage of advancements in autonomous processes that allow unmonitored autonomous operation of the first vehicle through onboard autonomous control systems, such that the first vehicle may autonomously operate to assist the operator when operating the second vehicle. The operator may switch between being an occupant of the autonomous motor vehicle (which may be referred to as a primary vehicle) and actively operating the second vehicle (which may be referred to as a secondary vehicle) at any time during travel between a first location and a second location without considering an operational context (e.g., a distance between the first and second locations, expected weather conditions while traveling, traffic conditions of the route used to travel between the first and second locations, etc.).

The techniques may further allow for the primary vehicle to provide various support services, such as a protection service, an illumination service, an alert service, an informational service, an entertainment service, a communication service, or any other service. The primary vehicle may be configured to obtain information relating to the secondary vehicle and provide the one or more support services based on the obtained information. For example, the primary vehicle may be configured to obtain information relating to the secondary vehicle from one or more of: one or more input devices of the secondary vehicle, one or more devices associated with the secondary vehicle (e.g., a computing device carried or worn by the operator of the secondary vehicle), and/or one or more input devices of the primary vehicle. In this respect, the primary vehicle may provide those benefits lacking during operation of the secondary vehicle to assist or otherwise improve the user experience while operating the secondary vehicle.

In one example, a method comprises receiving, by one or more processors of a first vehicle autonomously controlling operation of the first vehicle, vehicle information relating to a second vehicle, the second vehicle configured to be operated by an operator, and autonomously controlling positioning, by the one or more processors of the first vehicle and based on the information, the first vehicle at a location relative to the second vehicle so as to perform at least one service for the second vehicle.

In another example, a first vehicle comprises a memory configured to store vehicle information relating to a second vehicle, the second vehicle configured to be operated by an operator. The first vehicle also comprises one or more processors configured to autonomously control positioning, based on the vehicle information, the first vehicle at a location relative to the second vehicle, and perform, after reaching the location, at least one service for the second vehicle.

In another example, a method comprises determining, by one or more processors of a second vehicle, vehicle information relating to the second vehicle, the second vehicle configured to be operated by an operator, and transmitting, by the one or more processors, the vehicle information to a first vehicle autonomously controlling operation of the first vehicle in response to the vehicle information such that the first vehicle is able to autonomously position the first vehicle at a location relative to the second vehicle that allows the first vehicle to perform at least one service for the second vehicle.

In another example, a second vehicle comprises a processor configured to determine vehicle information relating to the second vehicle, the second vehicle configured to be operated by an operator. The second vehicle also comprises a memory configured to store the vehicle information. The second vehicle further comprises an interface configured to transmit the vehicle information to a first vehicle autonomously controlling operation of the first vehicle such that the first vehicle is able to autonomously position the first vehicle at a location relative to the second vehicle that allows the first vehicle to perform at least one service for the second vehicle.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system configured to perform various aspects of the vehicle assistance techniques described in this disclosure.

FIGS. 2A-2D are diagrams illustrating example operation of the primary vehicle of FIG. 1 in autonomously positioning the primary vehicle to provide protection services to the secondary vehicle of FIG. 1 in accordance with various aspects of the support service techniques described in this disclosure.

FIGS. 3A-3C are diagrams illustrating example operation of the primary vehicle of FIG. 1 in performing illumination services for the secondary vehicle of FIG. 1 in accordance with various aspects of the support service techniques described in this disclosure.

FIGS. 4A-4C are diagrams illustrating example operation of the primary vehicle of FIG. 1 in providing physical barrier protection services for the secondary vehicle of FIG. 1 in accordance with various aspects of the support service techniques described in this disclosure.

FIG. 5 is a diagram illustrating example operation of the primary vehicle of FIG. 1 in performing an information-providing service in accordance with various aspects of the support services techniques described in this disclosure.

FIG. 6 is a diagram illustrating example operation of the primary vehicle of FIG. 1 providing an alert service for the secondary vehicle of FIG. 1 in accordance with various aspects of the support service techniques described in this disclosure.

FIGS. 7A-7C are diagrams illustrating example operation of the primary vehicle of FIG. 1 in ceasing provisioning of services according to various aspects of the support service techniques described in this disclosure.

FIG. 8 is a flowchart illustrating example operation of the primary vehicle of FIG. 1 in performing various aspects of the support service techniques described in this disclosure.

FIG. 9 is a flowchart illustrating example operation of a secondary vehicle of FIG. 1 in performing various aspects of the support service techniques described in this disclosure.

FIG. 10 is an example in which two primary vehicles cooperate to provide support services to a secondary vehicle in accordance with various aspects of the support service techniques described in this disclosure.

FIG. 11 is a flowchart illustrating example operation of the primary vehicle shown in FIG. 10 in performing crowd sourcing aspects of the support services techniques described in this disclosure.

### DETAILED DESCRIPTION

In general, this disclosure describes techniques for improving the methodology of travel for a commuter. For example, the techniques of this disclosure are directed to positioning one or more primary vehicles near a secondary vehicle to perform one or more support services, such as protection, illumination, alerting, entertainment, communication, or any other service. A primary vehicle may be configured to obtain information relating to the secondary vehicle and provide the one or more support services based on the obtained information. For example, a primary vehicle may be configured to obtain information relating to the secondary vehicle from one or more of: one or more input devices of the secondary vehicle, one or more devices associated with the secondary vehicle (e.g., a computing device carried or worn by a rider of the secondary vehicle), and/or one or more input devices of the primary vehicle.

In some examples, in accordance with the techniques described herein, a commuter traveling from a first location to a second location may choose to operate a primary vehicle (e.g., a motorized vehicle) during at least one portion of the trip and a secondary vehicle (e.g., a non-motorized vehicle, such as a bicycle) during at least another portion of the trip. In such examples and in accordance with the techniques described herein, the commuter may arrive at the second location with both the primary vehicle and the secondary vehicle upon having commuted at least one portion of the commute with the primary vehicle and commuted at least another portion with the secondary vehicle. Otherwise described, in accordance with the techniques described herein, a commuter is no longer limited in choosing a single mode of transportation for traveling from a first location to a second location; rather, the techniques described herein enable the commuter to split the trip into one or more portions in which the commuter uses the primary vehicle to commute and one or more different portions in which the commuter uses the secondary vehicle to commute.

In some examples, the techniques described herein may improve safety for a commuter using a secondary vehicle to commute. For example, road sharing between secondary vehicles (e.g., bicycles and other non-motorized vehicles) and other vehicles (e.g., motorized vehicles) can be dangerous for commuters that use secondary vehicles because the secondary vehicles may be overlooked by operators of these other motorized vehicles and may provide less or inadequate protection in the event of a crash with these other motorized vehicles.

As used herein, the term “vehicle” may refer to a motorized or a non-motorized vehicle. As used herein, the term “motorized vehicle” may refer to a vehicle that may be configured to be propelled with a motor, such as an electric motor, a gas motor, a diesel motor, a hybrid motor, or any other type of motor. The term “motorized vehicle” may refer to a non-autonomous motorized vehicle, an autonomous motorized vehicle, a semi-autonomous motorized vehicle, or the like. In some examples, a motorized vehicle may be configured to operate in one of a plurality of modes of operation (e.g., at any given time, the motorized vehicle may be configured to operate in one of a plurality of modes of operation).

In such examples, a motorized vehicle may include at least two of the following modes of operation: autonomous, semi-autonomous, or non-autonomous. In this regard, reference herein to a type of motorized vehicle (e.g., an autonomous motorized vehicle) may refer to a mode in which the motorized vehicle may be configured to operate. Reference to an autonomous motorized vehicle may, for example, refer to a motorized vehicle configured to operate in only an autonomous mode, or a motorized vehicle configured to operate in an autonomous mode among other available selectable modes of operation.

As used herein, the term “autonomous motorized vehicle” may refer to a motorized vehicle configured to perform all driving functions (e.g., speed control, direction of travel, turning, braking, or any other driving function) on behalf of a commuter of the vehicle. For example, while a commuter of an autonomous motorized vehicle may configure one or more drive settings (e.g., max speed, minimum follow distance, or other drive settings), an autonomous motorized vehicle may be configured to drive itself consistent with drive settings.

As used herein, the term “semi-autonomous motorized vehicle” may refer to a motorized vehicle configured to perform at least one driving function on behalf of a commuter of the vehicle, and other driving functions may be performed by the commuter (e.g., rotating the steering wheel, engaging or disengaging movement pedal (e.g., gas pedal), engaging or disengaging the brake pedal, or the like). As used herein, the term “non-autonomous motorized vehicle” may refer to a motorized vehicle that is not an autonomous motorized vehicle and is not a semi-autonomous motorized vehicle. For example, the term “non-autonomous motorized vehicle” may refer to a motorized vehicle in which most, if not all, functions associated with controlling movement of the vehicle may be performed by a commuter of the vehicle.

As used herein, the term “non-motorized vehicle” may refer to a non-motorized vehicle that may be configured to be propelled without a motor, such as a unicycle, bicycle, tricycle, skateboard, roller skates, in-line roller skates, a scooter or any other non-motorized vehicle. As used herein, the term “primary vehicle” may refer to a motorized vehicle. For example, the term “primary vehicle” may refer to an autonomous motorized vehicle or a semi-autonomous motorized vehicle. As used herein, the term “secondary vehicle” may refer to a non-motorized vehicle. Although described with respect to a secondary vehicle, the techniques may be applied with respect to a pedestrian.

As used herein, the term “commuter” may refer to a person. A commuter may be an operator (e.g., a driver) or a passenger of a vehicle. For example, a commuter of a primary vehicle may be an operator or a passenger of the primary vehicle. As another example, a commuter of a secondary vehicle may be an operator or a passenger of the secondary vehicle.

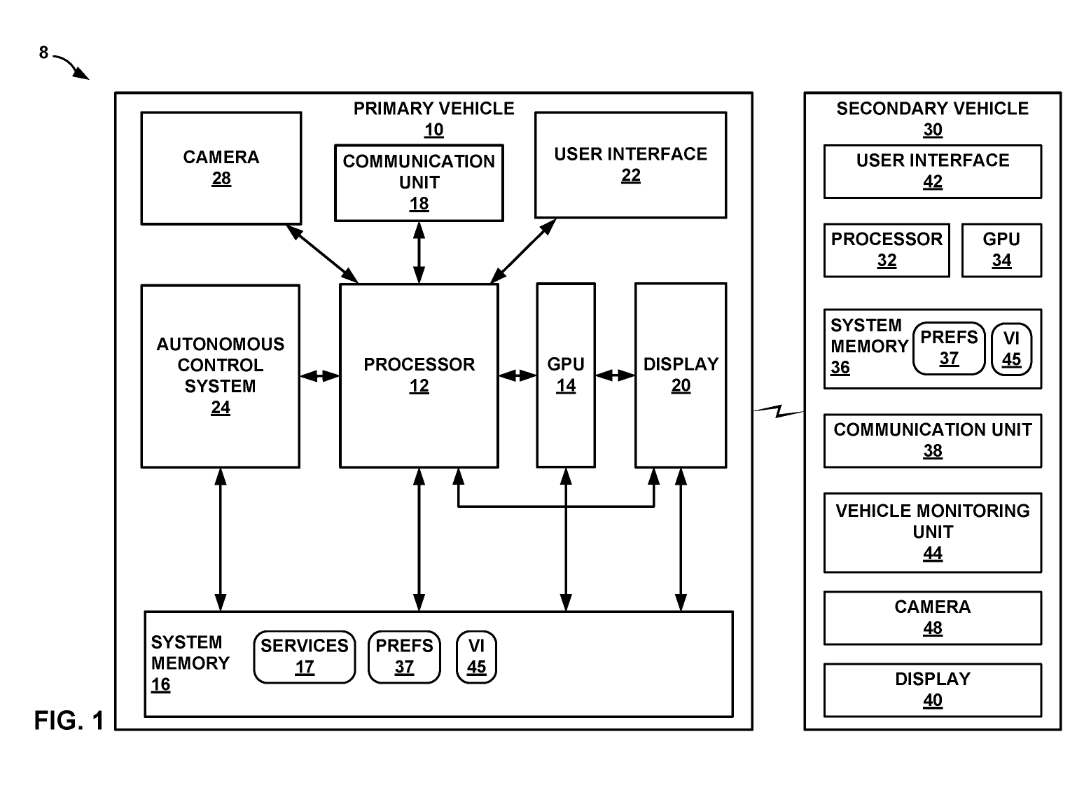

FIG. 1 is a block diagram illustrating an example system 8 configured to perform various aspects of the vehicle assistance techniques described in this disclosure. In the example of FIG. 1, system 8 includes a primary vehicle 10, which may represent an autonomous vehicle configured to automate one or more tasks associated with operation of vehicle 10, including automating most if not all of the tasks associated with operation of vehicle 10 such that a commuter need not, under most conditions, maintain awareness of a context in which vehicle 10 is operating.

Primary vehicle 10 is assumed in the description below to be an automobile. However, the techniques described in this disclosure may apply to any type of vehicle capable of conveying one or more occupants and being autonomously operated, such as a motorcycle, a bus, a recreational vehicle (RV), a semi-trailer truck, a tractor or other type of farm equipment, a train, a plane, a helicopter, a drone, a personal transport vehicle, and the like.

In the example of FIG. 1, primary vehicle 10 includes a processor 12, a graphics processing unit (GPU) 14, and system memory 16. In some examples, processor 12, and GPU 14 (as well as other components not shown in the example of FIG. 1), such as a transceiver may be formed as an integrated circuit (IC). For example, the IC may be considered as a processing chip within a chip package, and may be a system-on-chip (SoC).

Examples of processor 12 and GPU 14 may include fixed function processing circuitry and/or programmable processing circuitry, and may include, but not be limited to, one or more digital signal processors (DSPs), general purpose microprocessors, application specific integrated circuits (ASICs), field programmable logic arrays (FPGAs), or other hardware, including equivalent integrated or discrete logic circuitry. Processor 12 may be the central processing unit (CPU) of autonomous vehicle 10. In some examples, GPU 14 may be specialized hardware that includes integrated and/or discrete logic circuitry that provides GPU 14 with massive parallel processing capabilities suitable for graphics processing. In some instances, GPU 14 may also include general purpose processing capabilities, and may be referred to as a general purpose GPU (GPGPU) when implementing general purpose processing tasks (i.e., non-graphics related tasks).

Processor 12 may execute various types of applications. Examples of the applications include navigation applications, vehicle control applications, scheduling application, safety applications, web browsers, e-mail applications, spreadsheets, video games, or other applications that generate viewable objects for display. System memory 16 may store instructions for execution of the one or more applications. The execution of an application on processor 12 causes processor 12 to produce graphics data for image content that is to be displayed. Processor 12 may transmit graphics data of the image content to GPU 14 for further processing based on instructions or commands that processor 12 transmits to GPU 14.

Processor 12 may communicate with GPU 14 in accordance with a particular application processing interface (API). Examples of such APIs include the DirectX® API by Microsoft®, OpenGL® or OpenGL ES®by the Khronos group, and OpenCL™; however, aspects of this disclosure are not limited to the DirectX, the OpenGL, or the OpenCL APIs, and may be extended to other types of APIs. Moreover, the techniques described in this disclosure are not required to function in accordance with an API, and processor 12 and GPU 14 may utilize any technique for communication.

System memory 16 may be the memory for device 10. System memory 16 may comprise one or more computer-readable storage media. Examples of system memory 16 include, but are not limited to, a random access memory (RAM), an electrically erasable programmable read-only memory (EEPROM), flash memory, or other medium that can be used to carry or store desired program code in the form of instructions and/or data structures and that can be accessed by a computer or a processor.

In some aspects, system memory 16 may include instructions that cause processor 12 to perform the functions ascribed in this disclosure to processor 12. Accordingly, system memory 16 may be a computer-readable storage medium having instructions stored thereon that, when executed, cause one or more processors (e.g., processor 12) to perform various functions.

System memory 16 may represent a non-transitory storage medium. The term “non-transitory” indicates that the storage medium is not embodied in a carrier wave or a propagated signal. However, the term “non-transitory” should not be interpreted to mean that system memory 16 is non-movable or that its contents are static. As one example, system memory 16 may be removed from primary vehicle 10, and moved to another device. As another example, memory, substantially similar to system memory 16, may be inserted into autonomous vehicle 10. In certain examples, a non-transitory storage medium may store data that can, over time, change (e.g., in RAM).

As further shown in the example of FIG. 1, primary vehicle 10 may include a display 20 and a user interface 22. Display 20 may represent any type of passive reflective screen on which images can be projected, or an active reflective, emissive, or transmissive display capable of projecting images (such as a light emitting diode (LED) display, an organic LED (OLED) display, liquid crystal display (LCD), or any other type of active display). Although shown as including a single display 20, autonomous vehicle 10 may include a plurality of displays that may be positioned throughout the cabin of primary vehicle 10, facing either inward so that occupants of primary vehicle 10 may view content presented by display 20 or outward such that persons outside of primary vehicle 10 may view content presented by display 20.

In some examples, passive versions of display 20 or certain types of active versions of display 20 (e.g., OLED displays) may be integrated into seats, tables, roof liners, flooring, windows (or in vehicles with no windows or few windows, walls) or other aspects of the cabin of autonomous vehicles. When display 20 represents a passive display, display 20 may also include a projector or other image projection device capable of projecting or otherwise recreating an image on passive display 20.

Display 20 may also represent displays in wired or wireless communication with autonomous vehicle 10. Display 20 may, for example, represent a computing device, such as a laptop computer, a heads-up display, a head-mounted display, an augmented reality computing device or display (such as “smart glasses”), a virtual reality computing device or display, a mobile phone (including a so-called “smart phone”), a tablet computer, a gaming system, or another type of computing device capable of acting as an extension of, or in place of, a display integrated into primary vehicle 10.

User interface 22 may represent any type of physical or virtual interface with which a user may interface to control various functionalities of primary vehicle 10. User interface 22 may include physical buttons, knobs, sliders or other physical control implements. User interface 22 may also include a virtual interface whereby an occupant of primary vehicle 10 interacts with virtual buttons, knobs, sliders or other virtual interface elements via, as one example, a touch-sensitive screen, or via a touchless interface (e.g., an audio-based interface in which commands are entered via speech). The occupant may interface with user interface 22 to control one or more of a climate within primary vehicle 10, audio playback by primary vehicle 10, video playback by primary vehicle 10, transmissions (such as cellphone calls, video conferencing calls, and/or web conferencing calls) through primary vehicle 10, or any other operation capable of being performed by primary vehicle 10.

User interface 22 may also represent interfaces extended to display 20 when acting as an extension of, or in place of, a display integrated into primary vehicle 10. That is, user interface 22 may include virtual interfaces presented via the above noted HUD, augmented reality computing device, virtual reality computing device or display, tablet computer, or any other of the different types of extended displays listed above.

In the context of primary vehicle 10, user interface 22 may further represent physical elements used for manually or semi-manually controlling primary vehicle 10. For example, user interface 22 may include one or more steering wheels for controlling a direction of travel of primary vehicle 10, one or more pedals for controlling a rate of travel of primary vehicle 10, one or more hand brakes, etc.

Primary vehicle 10 may further include an autonomous control system 24, which represents a system configured to autonomously operate one or more aspects of vehicle 10 without requiring intervention by an occupant of primary vehicle 10. Autonomous control system 24 may include various sensors and units, such as a global positioning system (GPS) unit, one or more accelerometer units, one or more gyroscope units, one or more compass units, one or more radar units, one or more LiDaR (which refers toLight Detection and Ranging) units, one or more cameras, one or more sensors for measuring various aspects of vehicle 10 (such as a steering wheel torque sensor, steering wheel grip sensor, one or more pedal sensors, tire sensors, tire pressure sensors), and any other type of sensor or unit that may assist in autonomous operation of vehicle 10.

Additionally, primary vehicle 10 may include a camera 28 and communication unit. Camera 28 may represent any device capable of capturing one or more images, including a sequence of images that form video data. Camera 28 may include a digital camera having an image sensor that converts light of different frequencies into electrical signals. The image sensor may comprise one or more of a semiconductor charge-coupled device (CCD) sensor, a complementary metal-oxide-semiconductor (CMOS) sensor, and an N-type metal-oxide-semiconductor (NMOS) sensor. Camera 28 may be mounted to view occupants in the cabin of primary vehicle 10 or mounted externally to view the area around primary vehicle 10. While described as having a single camera 28, primary vehicle 10 may include additional cameras similar to camera 28.

Communication unit 18 may represent a unit configured to transmit and receive (which may be referred to as a “transceiver” or “transceiver unit”) data via a wired or wireless communication channel. The transceiver may implement one or more protocols by which the data may be transmitted and/or received, such as one or more of the Bluetooth™ wireless personal network protocols, the Institute of Electrical and Electronics Engineers 802.11A/B/C/G/N/AC wireless Internet protocols, cellular data protocols (including the Long-Term Evolution—LTE—standard, Third Generation—3G—wireless mobile communication standards, etc.) and any other proprietary or non-proprietary, wired or wireless communication protocols. Communication unit 18 may also implement, in some examples, vehicle to everything (V2X) communication protocols, such as those specified as part of the WLAN IEEE 802.11 family of standards and commonly referred to as Wireless Access in Vehicular Environments (WAVE).

As also shown in FIG. 1, system 8 includes a secondary vehicle 30. Secondary vehicle 30 may represent, as noted above, a non-motorized vehicle that is manually operated by the commuter. Secondary vehicle 30 may include, either as components integrated into secondary vehicle 30 itself or via a separate computing device or devices attached to secondary vehicle 30 or accessible via the commuter (e.g., in the form of a mobile handset or so-called “smart phone,” tablet computer, laptop computer, smart watch, etc.), a processor 32, a GPU 34, a system memory 36, a communication unit 38, a display 40, a user interface 42, a vehicle monitoring unit 44, and a camera 48.

Processor 32 may be similar to, or substantially similar to, processor 12, while GPU 34 may be similar to, or substantially similar to GPU 14. Similarly, system memory 36 may be similar to, or substantially similar to, system memory 16. Communication unit 38 may be similar to, or substantially similar to, communication unit 18. Display 40 may be similar to, or substantially similar to, display 20. User interface 42 may be similar to user interface 42 insofar as user interface 42 may include the virtual interfaces, touchscreen input devices, virtual and/or physical keyboard input devices, virtual and/or physical pointer devices (e.g., a mouse) or any other virtual or physical input device commonly used to interface with a mobile computing device (such as a smart phone, tablet computer, or laptop computer to provide a few examples) or integrated components of secondary vehicle 30. Camera 48 may be similar to, or substantially similar to, camera 28.

Vehicle monitoring unit 44 may represent a unit configured to monitor secondary vehicle 30. While shown as a single unit for ease of illustration purposes, vehicle monitoring unit 44 may include, in some examples, two or more components residing in different devices that operate to form a single vehicle monitoring unit 44. For example, one component of vehicle monitoring unit 44 may include sensors to monitor one or more of a rate of travel (or, in other words, speed) of secondary vehicle 30, a state of the brake calipers (e.g., an amount of force applied by the brake calipers to the wheel to denote extent of braking), an angle of the handlebars relative to the frame (e.g., to denote whether the operator is turning), and the like. Another component of vehicle monitoring unit 44 may exist in a mobile communication device that includes a unit to collect the data from the sensors and package the data for communication via communication unit 38 to primary vehicle 10 via communication unit 18. However, in some instances, both components of vehicle monitoring unit 44 are a single unit integrated into secondary vehicle 30.

In some instances, a commuter traveling from a first location to a second location may choose to operate only one of a primary vehicle or a secondary vehicle. That is, commuters may only have access to non-autonomous or semi-autonomous primary vehicles that require the commuter to control all or most of the operation of the primary vehicle. Given that both the primary vehicle and the secondary vehicle must be manually operated in this example, the commuter (which may also be referred to as the “operator”) may select which of the first or second vehicles to operate. The primary vehicle may provide some benefits in terms of convenience (e.g., being operational in most types of weather, offering amenities such as air conditioning, heat, etc.), speed of travel (in good traffic conditions), and extensive safety measures (compared to most secondary vehicles), but lack other benefits, such as providing opportunities for exercise. The secondary vehicle may provide benefits the primary vehicle lacks, such as providing exercise, but lack the benefits provided by the primary vehicle, such as convenience, speed of travel (in good traffic conditions), and extensive safety measures.

The commuter often selects which of the primary and secondary vehicles to operate while traveling to the second location based on the operational context while travelling between the first and second locations. The operational context may, for example, include one or more of a distance between the first and second destination, expected weather conditions while traveling, traffic conditions of the route used to travel between the first and second locations, etc. The ability to only operate one of the primary vehicles and the secondary vehicles may potentially deprive the commuter of at least some benefits of traveling by way of the unselected primary or secondary vehicle. Furthermore, the operational context may unexpectedly change (e.g., the weather condition may change) while traveling to the second location such that the original choice of vehicle would not have been selected given the new unexpected operational choice, further depriving the commuter of potential benefits of the unselected primary or secondary vehicle.

In accordance with various aspects of the techniques described in this disclosure, an operator may experience the benefits of travel by way of both primary vehicle 10 and secondary vehicle 30. Taking advantage of advancements in autonomous processes that allow unmonitored autonomous operation of primary vehicle 10 through onboard autonomous control system 24, primary vehicle 10 may autonomously operate to assist the operator when operating secondary vehicle 30. The operator may switch between being an occupant of autonomous primary vehicle 10 and actively operating secondary vehicle 30 at any time during travel between a first location and a second location without considering the above noted operational context.

In operation, the commuter may interface with secondary vehicle 30 (or a device associated with secondary vehicle 30) to enter, via user interface 42, preferences 37 (“PREFS 37”). The commuter may define preferences 37 (which may also be referred to as “preference information 37”) for services to be provided by primary vehicle 10 while the commuter is operating secondary vehicle 30, where the preferences 37 define various preferences regarding which services to provide and how the primary vehicle 10 is to provide the selected services. Processor 32 may receive preferences 37 and store preferences 37 to system memory 36. As such, system memory 36 may represent a memory configured to store preferences 37.

When the commuter either begins operating secondary vehicle 30 or initiates services provided by primary vehicle 10 via user interface 42 of secondary vehicle 30, processor 32 may interface with communication unit 38 to transmit preferences 37 stored to system memory 36 to primary vehicle 10. Processor 12 of primary vehicle 10 may receive preferences 37 via communication unit 18 and store the preferences 37 to system memory 16. As such, system memory 16 may also represent a memory configured to store preferences 37.

Processor 12 may access preferences 37 and configure one or more services 17. Services 17 may represent one or more software routines that control autonomous operation of primary vehicle 10 by autonomous control system 24.

In order to provide service 17 indicated by preferences 37, processor 12 may interface with secondary vehicle 30 via communication unit 18 to determine vehicle information relating to secondary vehicle 30. Secondary vehicle 30 may interface with vehicle monitoring unit 44 to determine vehicle information (“VI 45”). Vehicle information 45 may specify one or more of a rate of travel of secondary vehicle 30, a degree of handlebars relative to the frame of secondary vehicle 30, an extent of braking by the commuter operating secondary vehicle 30, an approximate location of secondary vehicle 30 (as denoted by a global positioning system—GPS), and the like. Based on vehicle information 45, autonomous control system 24 may autonomously position primary vehicle 10 at a location relative to secondary vehicle 30 so as to perform services 17 indicated by preferences 37 for secondary vehicle 30.

Examples of services 17 may include a protection service, an illumination service, an alert service, an entertainment service, and an information-providing service. The protection service may include autonomous control system 24 autonomously positioning primary vehicle 10 at a location relative to secondary vehicle 30 to protect secondary vehicle 30 from other vehicles operating in a vicinity of the secondary vehicle 30. The illumination service may include autonomous control system 24 autonomously positioning primary vehicle 10 at the location relative to the secondary vehicle 30 to illuminate an area nearby or around secondary vehicle 30. The illumination service may enhance visibility of secondary vehicle 30 during night time, dusk, or early morning hours or other times when visibility may be difficult (e.g., in certain weather conditions).

The alert service may include autonomous control system 24 autonomously positioning primary vehicle 10 at a location relative to secondary vehicle 30 to issue an audible or visual alert to other vehicles in a vicinity of secondary vehicle with regard to current or upcoming operation of secondary vehicle 30. Autonomous control system 24 may issues alerts based on vehicle information 45 where such alerts may indicate that secondary vehicle 30 is changing lanes, turning, stopping, and/or accelerating. The alerts may also denote operation of primary vehicle 10, where such alerts may denote that the primary vehicle 10 is actively providing services 17 for secondary vehicle 30

The entertainment service may include autonomous control system 24 autonomously positioning primary vehicle 10 at the location such that outward facing display 20 is visible to the commuter operating secondary vehicle 30 so that the commuter is able to consume information. The information displayed by display 20 may include navigation information, entertainment information, operator condition information indicative of a condition of the operator of the second vehicle, vehicle condition information indicative of a condition of the second vehicle, forward-view information indicative of a view in front of first vehicle, traffic information indicative of traffic conditions, and point of interest information indicative of interesting features along a route of travel.

In this way, the techniques may allow for primary vehicle 10 to provide various support services, such as a protection service, an illumination service, an alert service, an informational service, an entertainment service, a communication service, or any other service. Primary vehicle 10 may be configured to obtain information relating to secondary vehicle 30 and provide the one or more support services based on the obtained information. For example, primary vehicle 10 may be configured to obtain information relating to secondary vehicle 30 from one or more of: one or more input devices of the secondary vehicle, one or more devices associated with secondary vehicle 30 (e.g., a computing device carried or worn by the operator of secondary vehicle 30), and/or one or more input devices of primary vehicle 10. As such, primary vehicle 10 may provide those benefits lacking during operation of secondary vehicle 30 to assist or otherwise improve the user experience while operating secondary vehicle 30.

Although assumed to be an autonomous or semi-autonomous vehicle in this disclosure, primary vehicle 10 may represent a non-autonomous vehicle. As such, the techniques described in this disclosure may be extended to non-autonomous vehicles where an operator actively controls operation of primary vehicle. Although control of operation of primary vehicle 10 may not be autonomous, certain aspects of the techniques described in this disclosure may be autonomously performed by primary vehicle 10, such as the various services described in this disclosure.

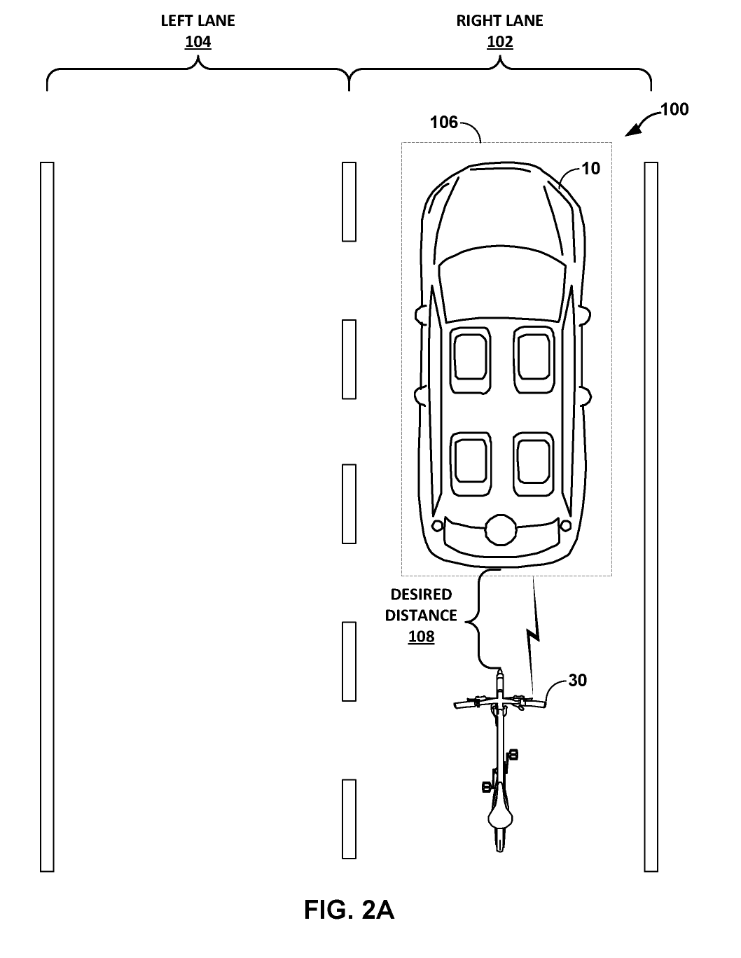

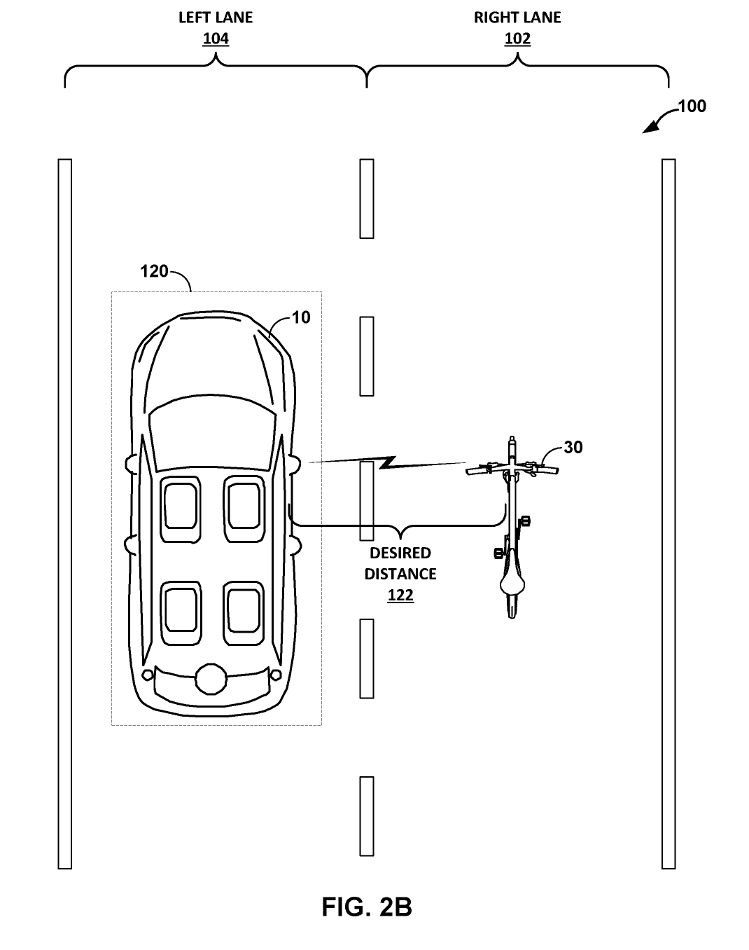

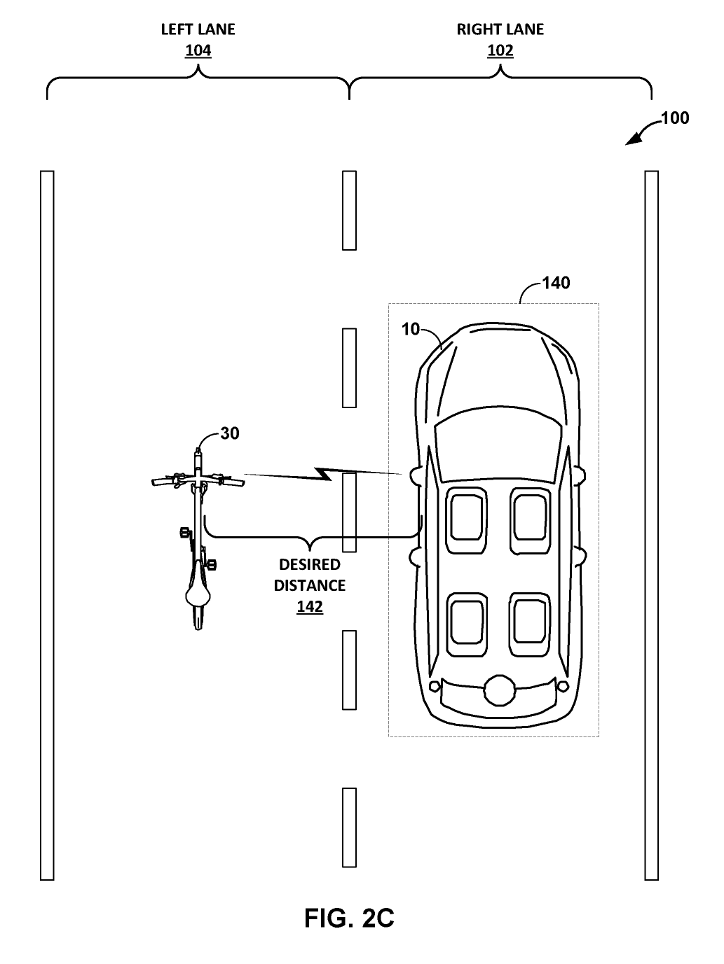

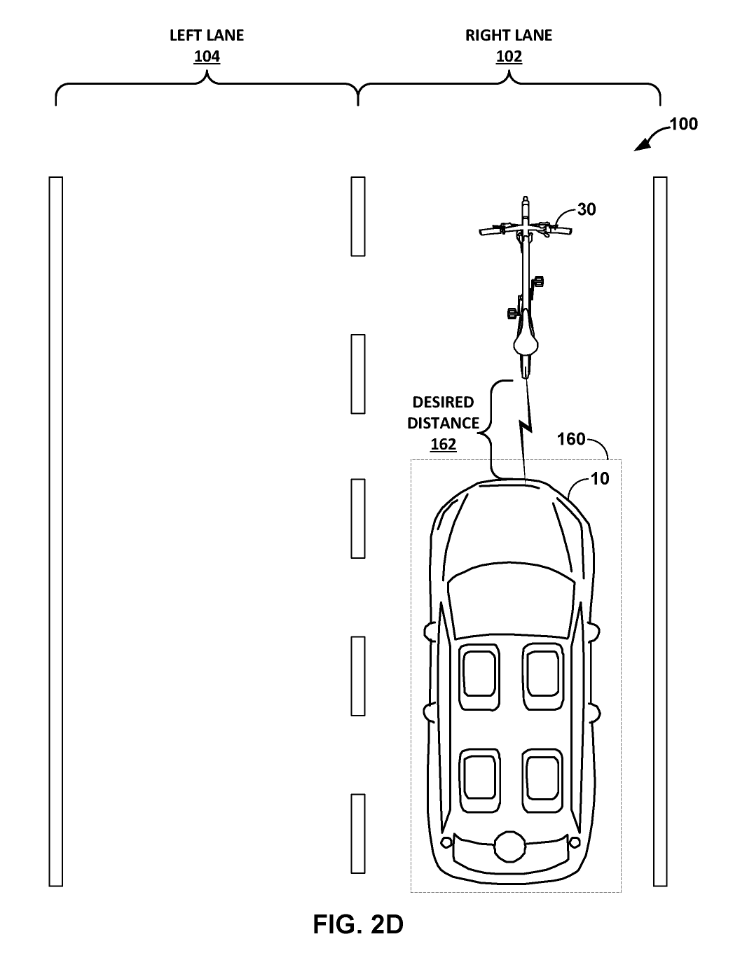

FIGS. 2A-2D are diagrams illustrating example operation of primary vehicle 10 in autonomously positioning primary vehicle 10 to provide protection services to secondary vehicle 30 in accordance with various aspects of the support service techniques described in this disclosure. In the example of FIG. 2A, preferences 37 may indicate that protection services 17 are preferred with primary vehicle 10 providing protection services 17 at a location in front of secondary vehicle 30.

A commuter (not shown in FIGS. 2A-2D for ease of illustration purposes) may operate secondary vehicle 30 (a bicycle in this example) in right lane 102 of road 100. Based on preferences 37 and vehicle information 45 indicating that secondary vehicle 30 is operating in right lane 102, processor 12 of primary vehicle 10 may determine a location 106 (which may also be referred to as a position 106) relative to secondary vehicle 30, where location 106 is in directly in front of secondary vehicle 30 as shown in the example of FIG. 2A.

Based on preferences 37 indicating a desired distance in front of secondary vehicle 30, processor 12 of primary vehicle 10 may determine location 106 (which may be referred to as a “preferred location 106”) to maintain a desired distance 108 directly in front of secondary vehicle 30. In some instances, the commuter may select desired distance 108 in a manner that emulates drafting conditions (or, in other words, slipstream conditions) for secondary vehicle 30 (which may, as shown in the example of FIG. 2A, be a bicycle). Drafting conditions may refer to an aerodynamic condition that allow two vehicles to align in a close group to reduce the overall effect of drag by exploiting the lead vehicle's slipstream.

In any event, after determining location 106, processor 12 may interface with autonomous control system 24 to autonomously position primary vehicle 10 at location 106, relative to the position of secondary vehicle 30, so as to provide the protection services (and possibly the drafting services depending on preferences 37) for secondary vehicle 30. That is, processor 12 may interface with autonomous control system 24 to position primary vehicle 10 at location 106 and continuously update that position to maintain a nearly constant relative distance from secondary vehicle 30. The commuter may change the operating state of secondary vehicle, e.g., accelerate, brake, turn, change lanes, etc., providing updating vehicle information 45 indicating such changes in the operating state to primary vehicle 10. Processor 12 may update location 106 to reflect the changing operating state indicated by vehicle information 45 (while maintaining desired distance 108) and interface with autonomous control system 24 to autonomously position primary vehicle 10 at updated location 106.

In the example of FIG. 2B, preferences 37 may indicate that protection services 17 are preferred with primary vehicle 10 providing protection services 17 at a location to the left of secondary vehicle 30. A commuter (again not shown in FIGS. 2A-2D for ease of illustration purposes) may operate secondary vehicle 30 in right lane 102 of road 100. Based on preferences 37 and vehicle information 45 indicating that secondary vehicle 30 is operating in right lane 102, processor 12 of primary vehicle 10 may determine a location 120 (which may also be referred to as a position 120) relative to secondary vehicle 30, where location 120 is to the left of secondary vehicle 30 as shown in the example of FIG. 2B.

Based on preferences 37 indicating a desired distance to the left of secondary vehicle 30, processor 12 of primary vehicle 10 may determine location 120 to maintain a desired distance 122 to the left of secondary vehicle 30. After determining location 120, processor 12 may interface with autonomous control system 24 to autonomously position primary vehicle 10 at location 120 so as to provide the protection services for secondary vehicle 30 (while maintaining desired distance 122). The commuter may change the operating state of secondary vehicle, e.g., accelerate, brake, turn, change lanes, etc., providing updating vehicle information 45 indicating such changes in the operating state to primary vehicle 10. Processor 12 may update location 120 to reflect the changing operating state indicated by vehicle information 45 (while maintaining desired distance 122) and interface with autonomous control system 24 to autonomously position primary vehicle 10 at updated location 120. In this manner, primary vehicle 10 may shield secondary vehicle 30 from other vehicles that may encroach on the space occupied by secondary vehicle 30.

In the example of FIG. 2C, preferences 37 may indicate that protection services 17 are preferred with primary vehicle 10 providing protection services 17 at a location to the right of secondary vehicle 30. A commuter (again not shown in FIGS. 2A-2D for ease of illustration purposes) may operate secondary vehicle 30 in left lane 104 of road 100. Based on preferences 37 and vehicle information 45 indicating that secondary vehicle 30 is operating in left lane 104, processor 12 of primary vehicle 10 may determine a location 120 (which may also be referred to as a position 120) relative to secondary vehicle 30, where location 120 is to the right of secondary vehicle 30 as shown in the example of FIG. 2C.

Based on preferences 37 indicating a desired distance to the right of secondary vehicle 30, processor 12 of primary vehicle 10 may determine location 120 to maintain a desired distance 142 to the right of secondary vehicle 30. After determining location 120, processor 12 may interface with autonomous control system 24 to autonomously position primary vehicle 10 at location 140 so as to provide the protection services for secondary vehicle 30 (while maintaining desired distance 142). The commuter may change the operating state of secondary vehicle, e.g., accelerate, brake, turn, change lanes, etc., providing updating vehicle information 45 indicating such changes in the operating state to primary vehicle 10. Processor 12 may update location 140 to reflect the changing operating state indicated by vehicle information 45 (while maintaining desired distance 142) and interface with autonomous control system 24 to autonomously position primary vehicle 10 at updated location 140.

In the example of FIG. 2D, a commuter (again not shown in FIGS. 2A-2D for ease of illustration purposes) may operate secondary vehicle 30 in right lane 102 of road 100. Based on preferences 37 indicating that primary vehicle 30 is to provide protection services at a location directly behind secondary vehicle 30 and maintain desired distance 162 and vehicle information 45 indicating that secondary vehicle 30 is operating in right lane 102 of road 100, processor 12 of primary vehicle 10 may determine a location 160 (which may also be referred to as a position 160) relative to secondary vehicle 30, where location 106 is in directly behind secondary vehicle 30 at desired distance 162 as shown in the example of FIG. 2D.

After determining location 160, processor 12 may interface with autonomous control system 24 to autonomously position primary vehicle 10 at location 160 so as to provide the protection services (and possibly the drafting services depending on preferences 37) for secondary vehicle 30. The commuter may change the operating state of secondary vehicle, e.g., accelerate, brake, turn, change lanes, etc., providing updating vehicle information 45 indicating such changes in the operating state to primary vehicle 10. Processor 12 may update location 160 to reflect the changing operating state indicated by vehicle information 45 (while maintaining desired distance 162) and interface with autonomous control system 24 to autonomously position primary vehicle 10 at updated location 160.

In the examples of each of FIGS. 2A-2D, autonomous control system 24 may position primary vehicle 10 at location 106, 120, 140, and 160 so as to protect secondary vehicle 30 from other vehicles in the vicinity of secondary vehicle 10. Autonomous control system 24 may identify the other vehicles in the vicinity of secondary vehicle 10 using LIDAR, vehicle to vehicle (V2V) communication, analysis of images captured by camera 28, and the like, and position vehicle in any one of locations 106, 120, 140, and 160 to provide a protective buffer zone between secondary vehicle 30 and the other cars in the vicinity of secondary vehicle 30. Such repositioning responsive to detection of the other vehicles may override preferences 37, as the safety of the commuter operating secondary vehicle 30 may, in some instances, represent the highest priority. Moreover, such repositioning may occur only when autonomous control system 24 detects that the other vehicles are being manually operated by a person, or when the other vehicles do not have the ability to detect secondary vehicle 30.

Although not explicitly shown in the examples of FIGS. 2A-2D, primary vehicle 10 may, when providing protective services, change appearance to designate that primary vehicle 10 is providing protective services. Changes in appearance may include presenting, via outward facing display 20, a message or graphic indicating protection services are currently activated, projecting via camera 28 various text and/or graphics on road 100 in front, behind, and/or to the sides of primary vehicle 30 indicating primary vehicle 10 is currently providing protection services, turning on hazard lights to indicate primary vehicle 10 is currently providing protection services, turning on supplemental lights, e.g., on the side or top of primary vehicle 10, and the like.

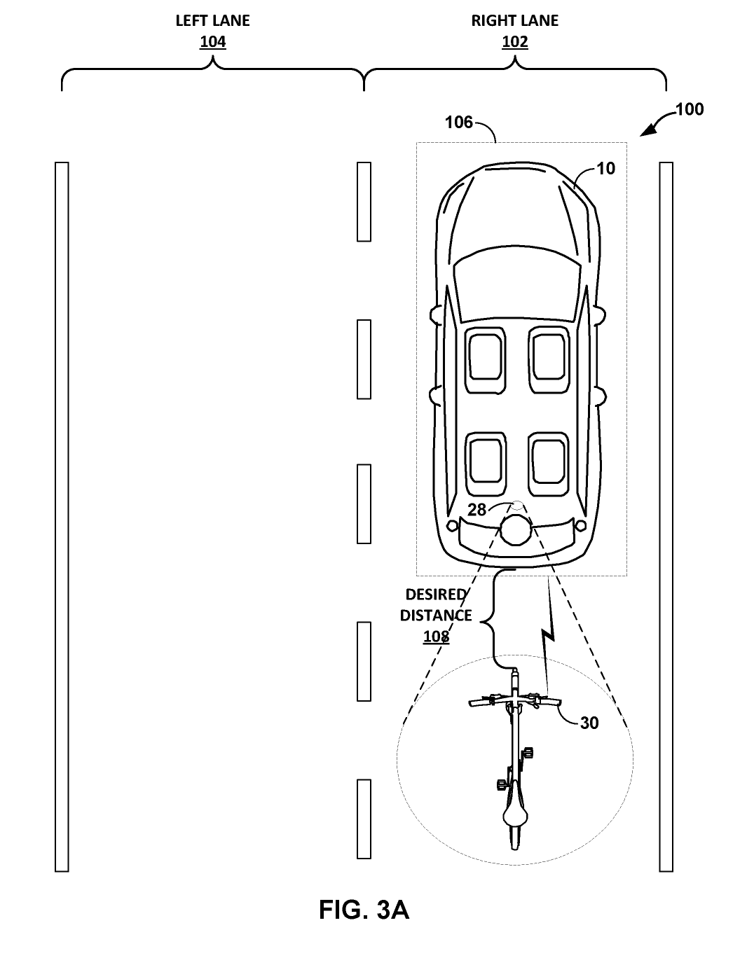

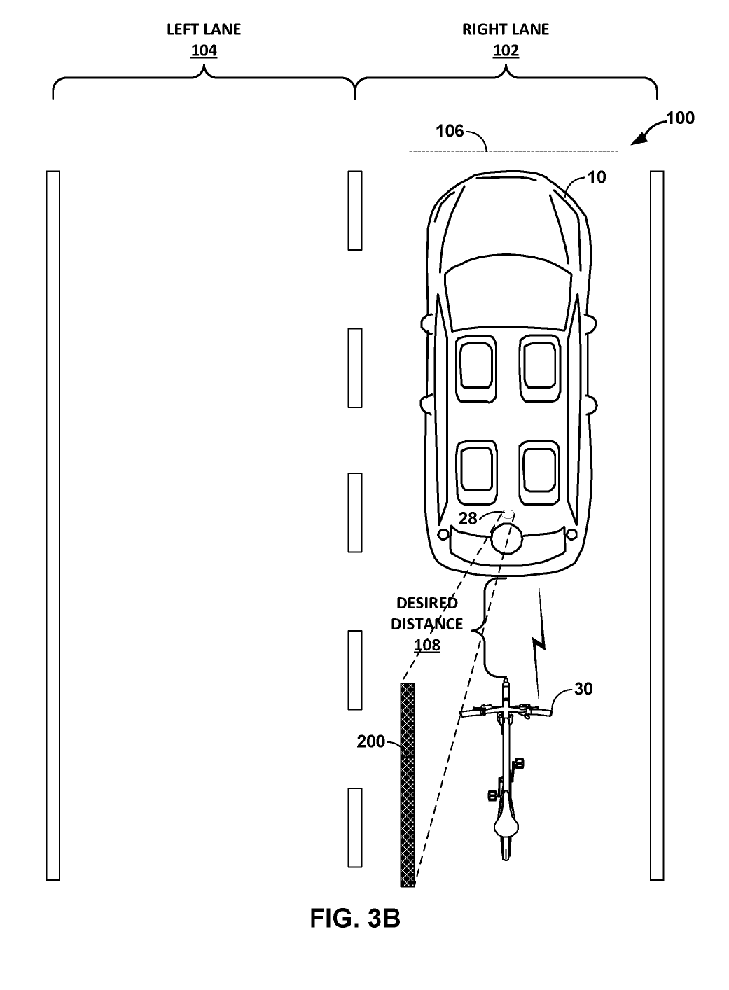

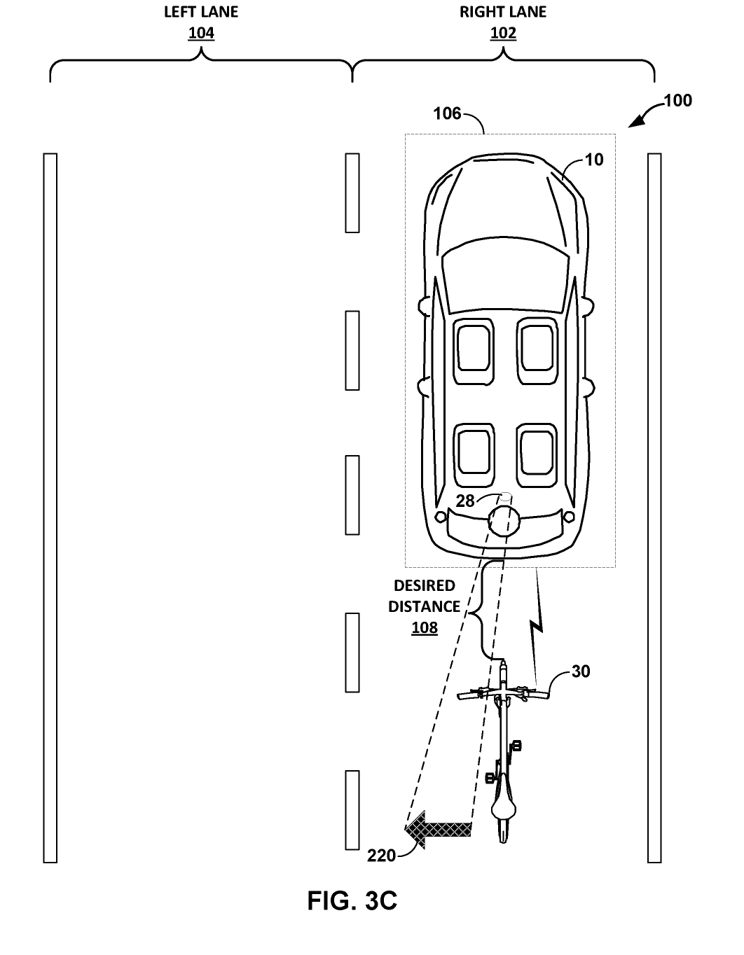

FIGS. 3A-3C are diagrams illustrating example operation of primary vehicle 10 in performing illumination services for secondary vehicle 30 in accordance with various aspects of the support service techniques described in this disclosure. In the example of FIG. 3A, camera 28 of primary vehicle 10 may include one or more lights (which in terms of a camera may be referred to as one or more flashes) capable of illuminating secondary vehicle 30. Although described as having light integrated with camera 28, primary vehicle 10 may include dedicated lights used for providing illumination services.

The illumination services may include projecting light at secondary vehicle 30 such that secondary vehicle 30 is more visible to other vehicles in the vicinity of secondary vehicle 30 or otherwise allowing the commuter to have better visibility of road 100. The projected light may include general lighting or patterned lighting, including patterns that may result in projection of a virtual bicycle lane.

Processor 12 may determine location 106 such that sufficient lighting of secondary vehicle 30, road 100, or other objects may be achieved. Processor 12 may interface with camera 28 to capture images (possibly in the form of video data) of secondary vehicle 30 and/or road 100. Processor 12 may analyze the captured images to determine whether secondary vehicle 30 and/or road 100 is sufficiently illuminated. Processor 12 may determine that illumination is sufficient by analyzing the images to determine approximate LUX (which is a measurement of illumination per unit area) surrounding secondary vehicle 30. Processor 12 may determine LUX values between 6 and 15 surrounding secondary vehicle 30 as “sufficient.”

Preferences 37 may also indicate a preferred illumination level (possible in terms of LUX, or in more general, low, medium and high). As such, processor 12 may compare the approximated LUX to the preferred LUX indicated by preferences 37, where a low illumination level may correspond to an approximated LUX between 6 and 9, a medium illumination level may correspond to an approximated LUX between 9 and 12, and a high illumination level may correspond to an approximate LUX between 12 and 15. Although specific ranges are given for sufficient LUX, other ranges may be possible and the support service techniques described in this disclosure should not be limited to the stated LUX ranges. Furthermore, the above LUX ranges assume outdoor roads at night, and may be adapted based on the time of day, current natural lighting conditions, current weather conditions, and other similar variables, such as the reflective nature of road 100 (whether concreate or asphalt surfaced as one example).

In the example of FIG. 3A, autonomous control system 24 autonomously positions primary vehicle 10 at location 106 to provide general lighting of secondary vehicle 30 such that secondary vehicle 30 is both more visible and the commuter operating secondary vehicle 30 has better visibility of road 100. In the example of FIG. 3B, autonomous control system 24 autonomously positions primary vehicle 10 at location 106 to project light such that virtual bike lane 200 is created alongside of secondary vehicle 30, thereby facilitating better awareness of secondary vehicle 30 and appropriate distances for other vehicles in the vicinity of secondary vehicle 30.

As noted above, primary vehicle 10 may determine, based on vehicle information 45, changes in operation of secondary vehicle 30. For example, primary vehicle 10 may determine, based on the commuter activating a turn signal control as indicated by vehicle information 45, that the commuter would like to change from right lane 102 to left lane 104. As shown in the example of FIG. 3C, primary vehicle 10 may, in response to determining that the commuter would like to change from right lane 102 to left lane 104, provide the illumination service so as to illuminate a virtual left blinker 220 on road 100. Although described as being dependent on vehicle information 45, autonomous control system 24 may determine that such lane changes (and turns) are upcoming via navigation functions and thereby provide virtual turn signal 220 responsive to upcoming navigational steps, thereby signaling both to the commuter and the other vehicles that secondary vehicle 30 will be changing lanes.

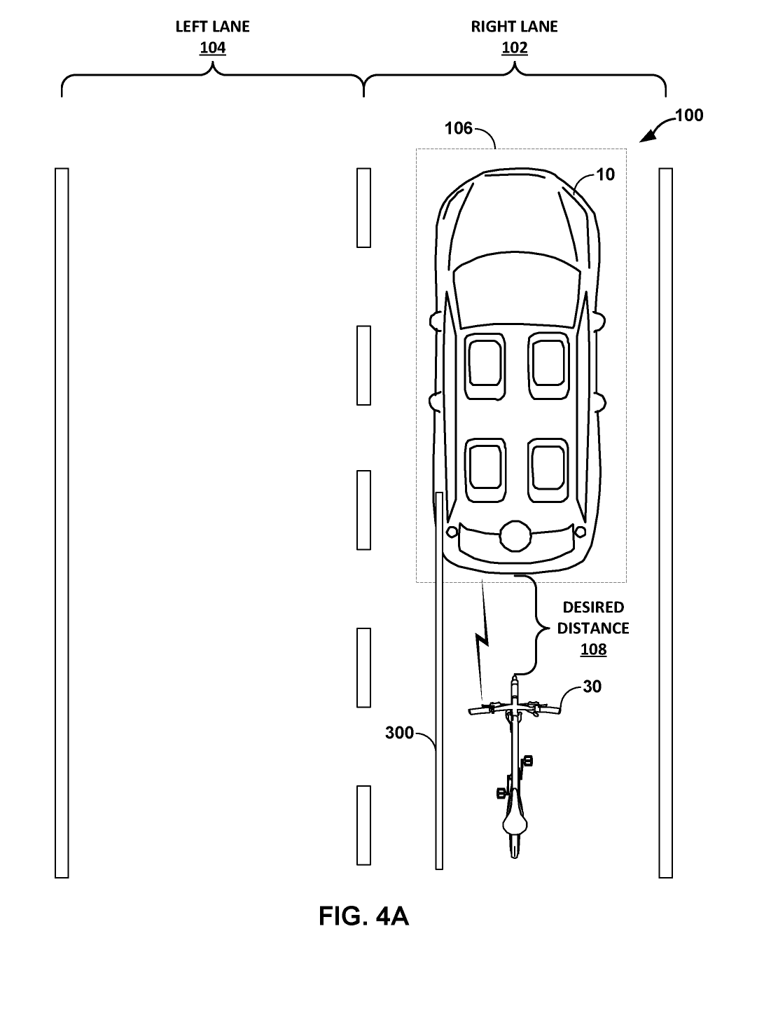

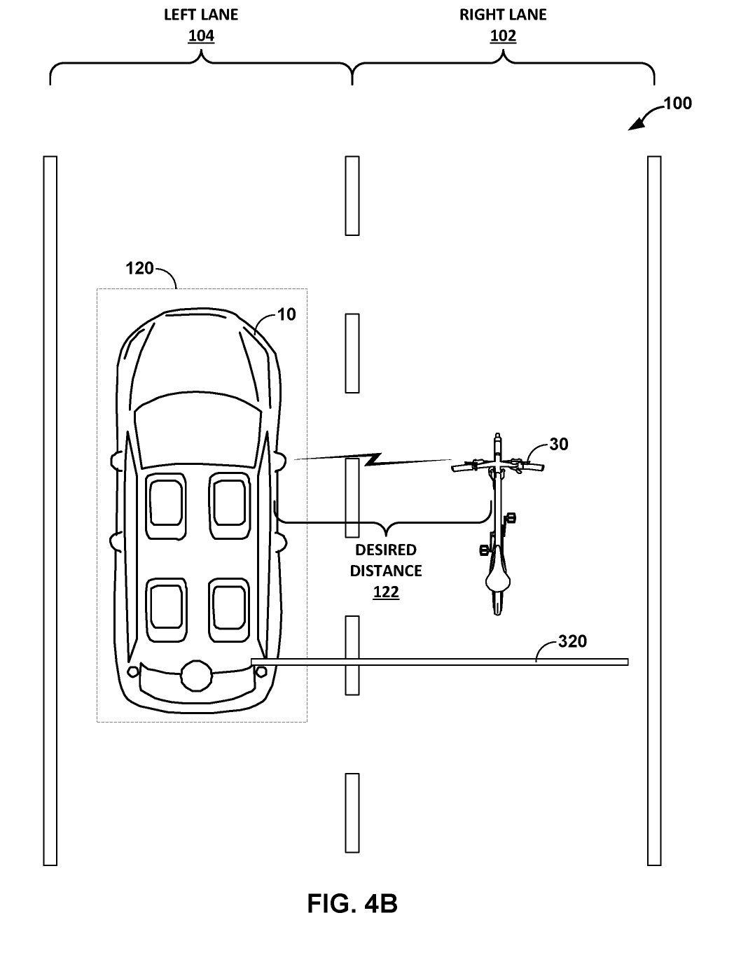

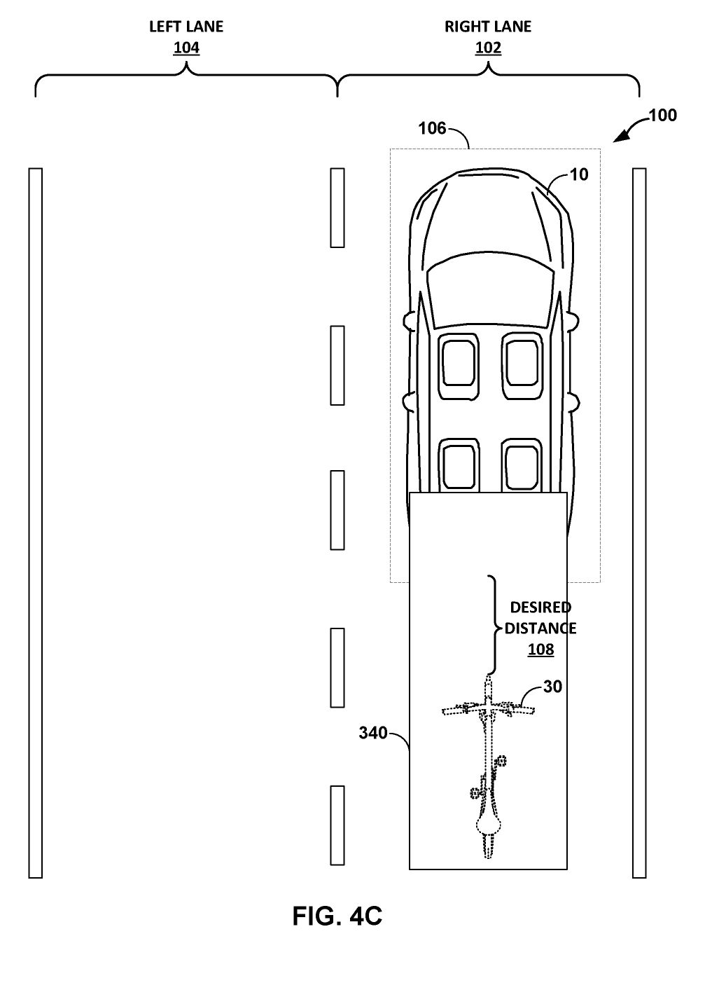

FIGS. 4A-4C are diagrams illustrating example operation of primary vehicle 10 in providing physical barrier protection services for secondary vehicle 30 in accordance with various aspects of the support service techniques described in this disclosure. As shown in the example of FIG. 4A, primary vehicle 10 may determine location 106 so as to deploy physical barrier 300 alongside secondary vehicle 30.

Similar to how preferences 37 may be overridden to prioritize safety for the illumination services, processor 12 of primary vehicle 10 may prioritize selection of location 106 such that barrier 300 extends all the way alongside secondary vehicle 30 even when location 106 may be closer than desired distance 108. Barrier 300 may include an extendable physical barrier, such as telescoping rods, that may be electronically deployed autonomously by autonomous control system 24. Barrier 300 may also include metal sheets, telescoping metal sheets, glass sheets, hard plastic sheets, and/or fabric, plastic, leather, and the like sheets supported by collapsible support structures that form walls protecting secondary vehicle 30. Preferences 37 may indicate a type of barrier (such as one of the foregoing listed types of barriers) to deploy when performing the protection services.

In the example of FIG. 4B, autonomous control system 24 of primary vehicle 10 deploys a physical barrier 320 behind secondary vehicle 30. Alternatively or in conjunction with deploying physical barrier 320 behind secondary vehicle 30, autonomous control system 24 may deploy a physical barrier in front of secondary vehicle 30. Although two examples are given in which physical barriers are deployed by primary vehicle alongside the secondary vehicle from a position in front of secondary vehicle 30 (e.g., FIG. 4A) and behind and/or in front of secondary vehicle 30 from a position on the left of secondary vehicle (e.g., FIG. 4B), autonomous control system 24 of primary vehicle 10 may deploy similar barriers from location 160 behind secondary vehicle 30 (similar to that shown in the example of FIG. 2D) and from location 140 on the right of secondary vehicle 30 (similar to that shown in the example of FIG. 2C).

Although shown as providing illumination services when positioned at location 106 directly in front of secondary vehicle 30, primary vehicle 10 may provide illumination services when positioned at any of locations 120, 140, and 160. Furthermore, the commuter may define priorities in preferences 37 which may dictate whether maintaining the desired distance is of a higher or lesser priority to maintaining a desired illumination level. In some instances, secondary vehicle 30 may predefine priorities based on approximated safety levels of secondary vehicle 30 given the current operating context. For example, when operating at night, secondary vehicle 30 may prioritize maintaining the illumination level over maintaining the desired distance.

In the example of FIG. 4C, autonomous control system 24 of primary vehicle 10 may deploy a physical barrier 340 above secondary vehicle 30 thereby providing a protection service from inclement weather, such as rain, snow, hail, sleet, etc. Barrier 360 may include metal sheets, telescoping metal sheets, glass sheets, hard plastic sheets, or fabric, plastic, leather, and/or the like sheets suspended by a collapsible support mechanism. Although shown as extending barrier 340 from location 106 directly in front of secondary vehicle 30, primary vehicle 10 may extend barriers 340 over secondary vehicle from any of locations 120, 140, and 160.

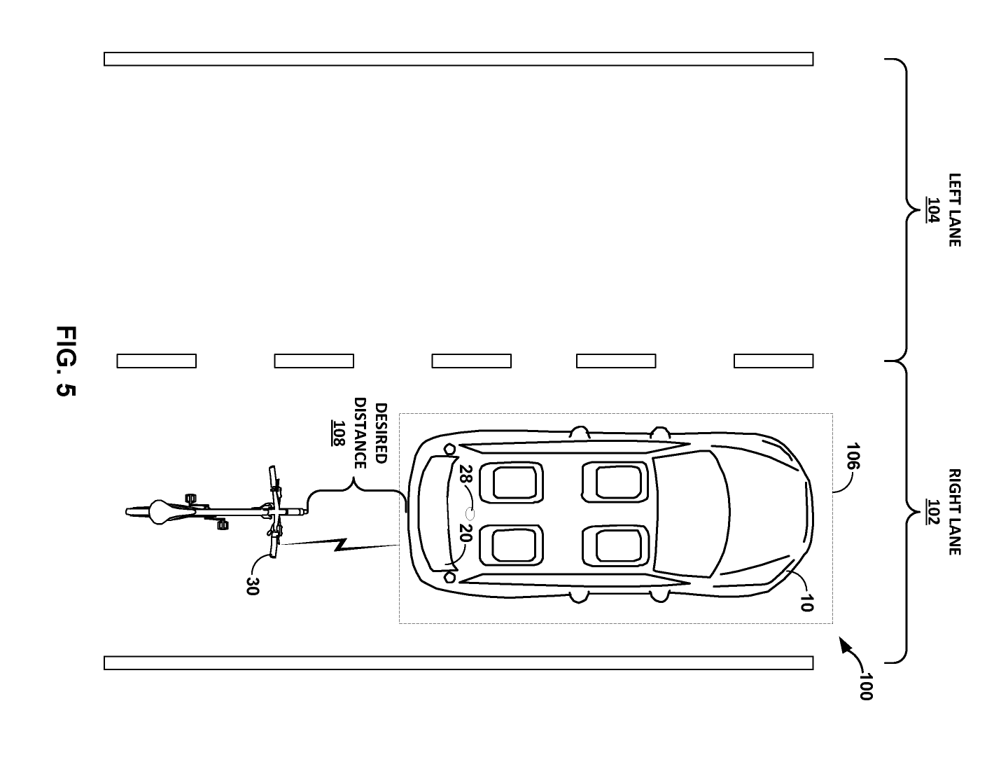

FIG. 5 is a diagram illustrating example operation of primary vehicle 10 in performing an information-providing service in accordance with various aspects of the support services techniques described in this disclosure. In the example of FIG. 5, autonomous control system 24 may autonomously position primary vehicle 10 at location 106 so as to provide information-providing services 17 via outward facing display 20 such that the commuter operating secondary vehicle 30 is able to consume (e.g., view and/or hear) information.

Processor 12 may interface with camera 28 to capture images, and analyze those images to determine an appropriate distance given a size of display 20 to maintain when presenting the information. Alternatively or in conjunction with employing camera 28, processor 12 may interface with autonomous control system 24 to determine how far away secondary vehicle 30 is from display 20, and determine location 106 based on the received distance between display 20 and secondary vehicle 30. In some instances, location 106 may not maintain desired distance 108 when priorities in preferences 37 indicate that consumption of information is a higher priority than a set desired distance 108.

The information may include any type of information. A few examples of such information that display 20 may display are navigation information, entertainment information (e.g., video and/or image data), operator condition information indicative of a condition of the operator of secondary vehicle 30 (e.g., heart rate, blood oxygen levels, respiratory rate, etc.), vehicle condition information indicative of a condition of secondary vehicle 30 (e.g., rate or speed of travel, current gear, incline, etc.), forward-view information captured by a forward looking camera 28 indicative of a view in front of primary vehicle 10, traffic information indicative of traffic conditions, and point of interest information indicative of interesting features along the route of travel.

When communicating some of the above information, such as the operator condition information, primary vehicle 10 may also present additional messages to motivate the operator of secondary vehicle. Primary vehicle 10 may also play audio such as music or speech, which may include motivational material. In this respect, primary vehicle 10 may present images, video and/or audio to emulate a personal trainer to encourage the commuter to reach certain goals or other criteria.

While described as being displayed via outward facing display 20, secondary vehicle 30 may project the information (via camera 28 or a separate dedicated projector not shown in FIG. 1 for ease of illustration purposes) onto the back of primary vehicle 10. When projecting information, secondary vehicle 30 may communicate via vehicle information 45 that projection of information is required, and processor 12 of primary vehicle 10 may interface with autonomous control system 24 to position primary vehicle 10 in an appropriate location to facilitate the projection of information on the back of primary vehicle 10.

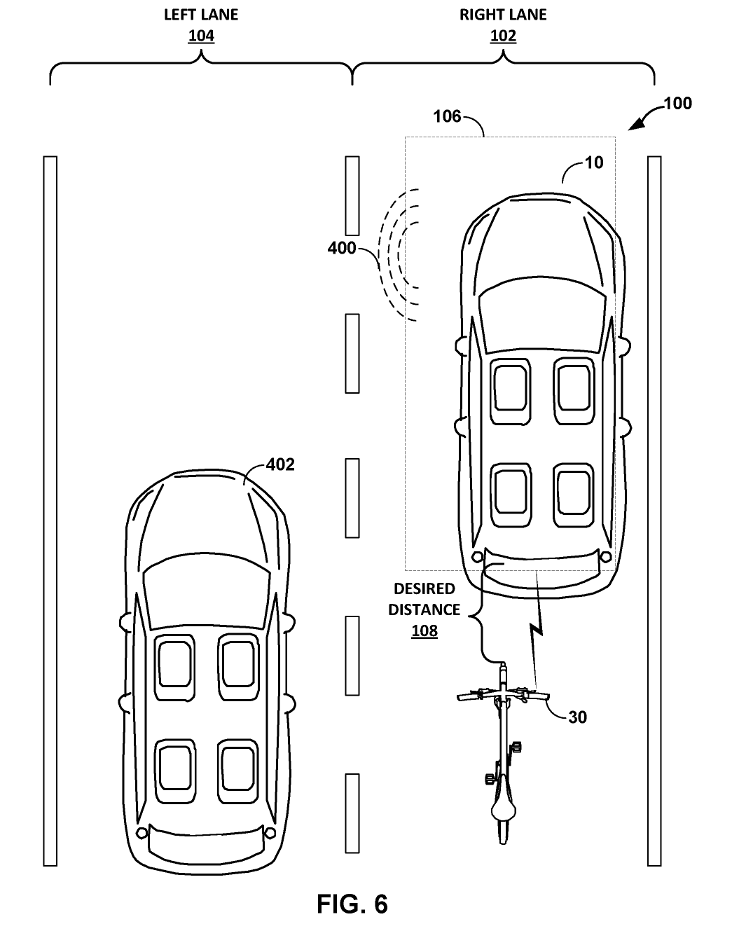

FIG. 6 is a diagram illustrating example operation of primary vehicle 10 providing an alert service for secondary vehicle 30 in accordance with various aspects of the support service techniques described in this disclosure. As shown in the example of FIG. 6, autonomous control system 24 may autonomously issue audible alert 400 to facilitate protection of secondary vehicle 10 upon detecting other vehicles, i.e., vehicle 402 in the example of FIG. 6, in the vicinity of secondary vehicle 30. In some instances, autonomous control system 24 may only issue alert 400 when vehicle 402 is manually operated by a person to ensure the person is aware of secondary vehicle 30. That is, autonomous control system 24 may not issue alert 400 after determining that vehicle 402 (via V2V communication) is autonomously controlled. However, when determining that vehicle 402 is autonomously controlled but does not have the capability to sense secondary vehicle 30, autonomous control system 24 may issue a non-audible alert 402 to communicate with vehicle 402 and thereby inform vehicle 402 of secondary vehicle 30.

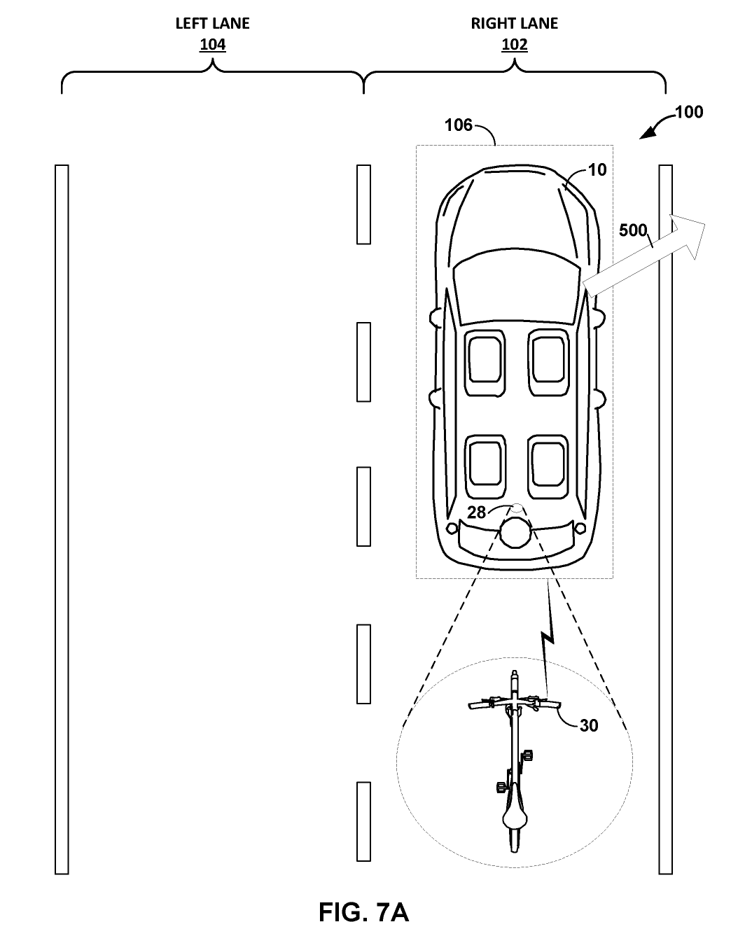

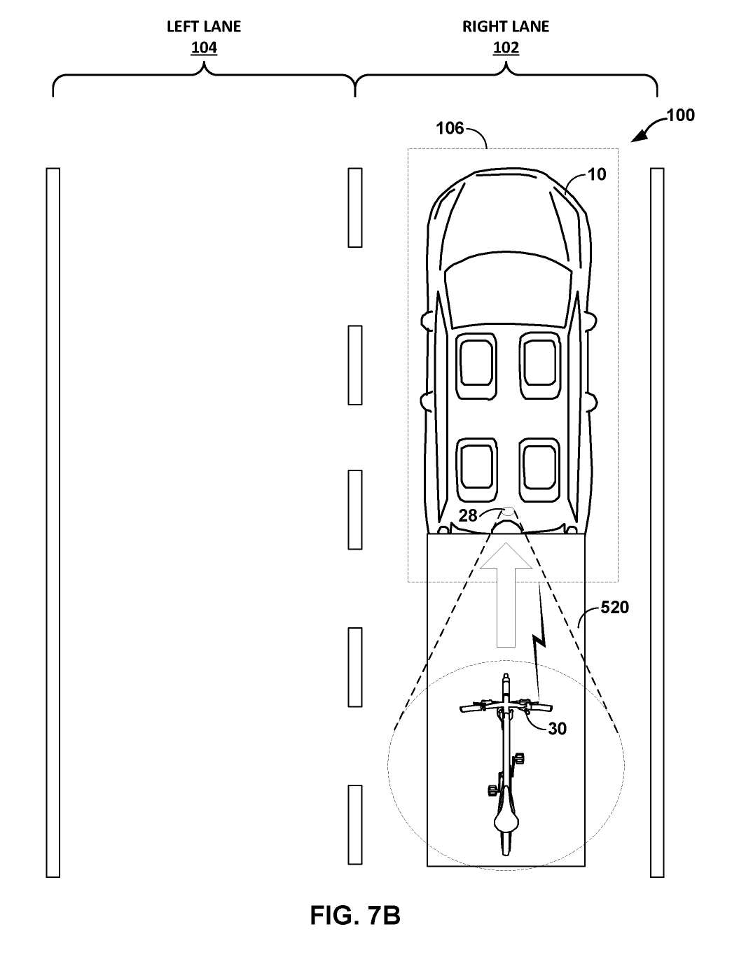

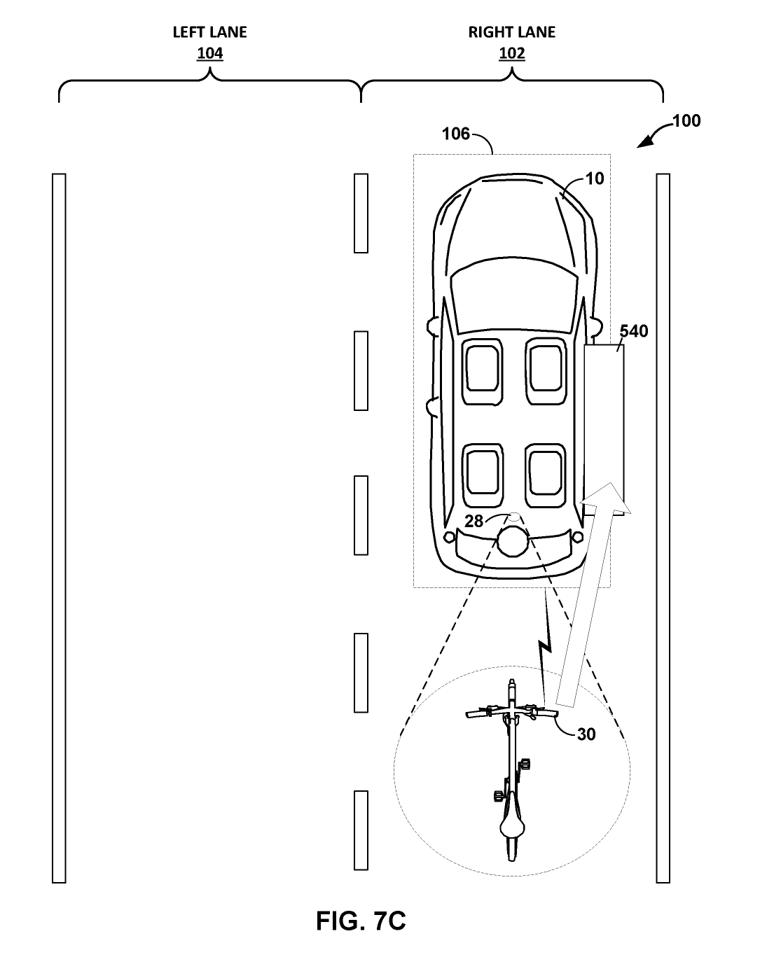

FIGS. 7A-7C are diagrams illustrating example operation of primary vehicle 10 in ceasing provisioning of services according to various aspect of the support service techniques described in this disclosure. In the example of FIG. 7A, primary vehicle 10 may employ camera 28 to capture images of the commuter. Processor 12 of primary vehicle 10 may analyze the captured images to detect gestures or other visual signals given by the commuter representative of various actions to be performed by the primary vehicle 10. These gestures or other visual signals may represent instructional information indicative of the actions to be performed by primary vehicle 10. Various actions may include providing an illumination service to signal a lane change, as described above, providing the protection service, providing the information-providing service and the like. Processor 12 may analyze the images to generate, based on the one or more visual signals, the instructional information indicative of the action.

In this example, the commuter may gesture for primary vehicle 10 to cease providing all services and pull over to the side of road 100 (or to some other designated safe stopping place) so that the commuter may enter primary vehicle 10. Processor 12 may capture image data and then analyze the image data to determine the one or more visual signals given by the commuter operating secondary vehicle 30 representative of the stop action to be performed by primary vehicle 10. Processor 12 may interface with autonomous control system 24 such that autonomous control system 24 may perform the stop action, pulling primary vehicle 10 over to the side of road 100 and stopping primary vehicle 10 as illustrated by arrow 500 in the example of FIG. 7A. The commuter may load secondary vehicle 30 onto or within primary vehicle 10.

Although described above with respect to gestures or other camera-based instructional information, the commuter may interface with user interface 42 of secondary vehicle 30 to specify the instructional information directly. Secondary vehicle 30 may then communicate the instructional information to primary vehicle 10, which may then perform the stop action in the manner described above.

In the example of FIG. 7B, primary vehicle 10 may determine the instructional information in the manner described above indicative of the stop action. However, rather than pull over and stop at the side of road 100, autonomous control system 24 may deploy ramp 520 and possibly slow down such that the commuter may operate secondary vehicle 30 to ascend ramp 520 and travel directly into primary vehicle 10. Once inside primary vehicle 10, the commuter may resume the commute to the intended destination.

In the example of FIG. 7C, primary vehicle 10 may determine the instructional information in the manner described above indicative of the stop action. However, rather than pull over and stop at the side of road 100 or deploy ramp 520, autonomous control system 24 may deploy dock 540 and possibly slow down to allow the commuter to operate secondary vehicle 30 to engage secondary vehicle 30 within dock 540. Once docked, the commuter may enter primary vehicle 10 and resume the commute to the intended destination.

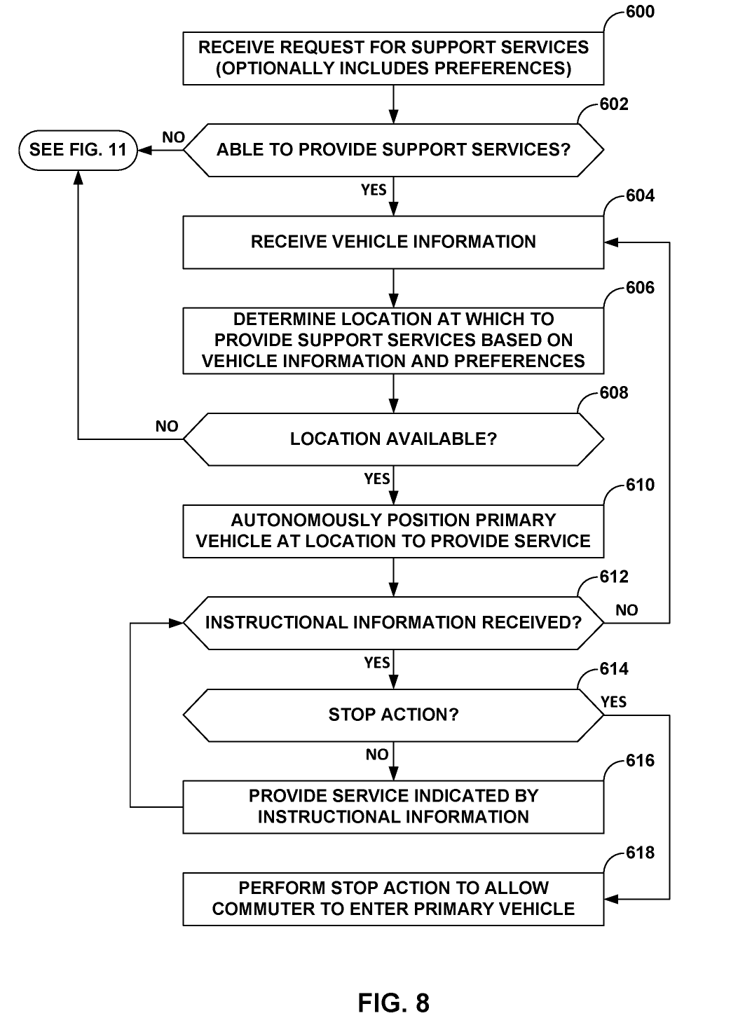

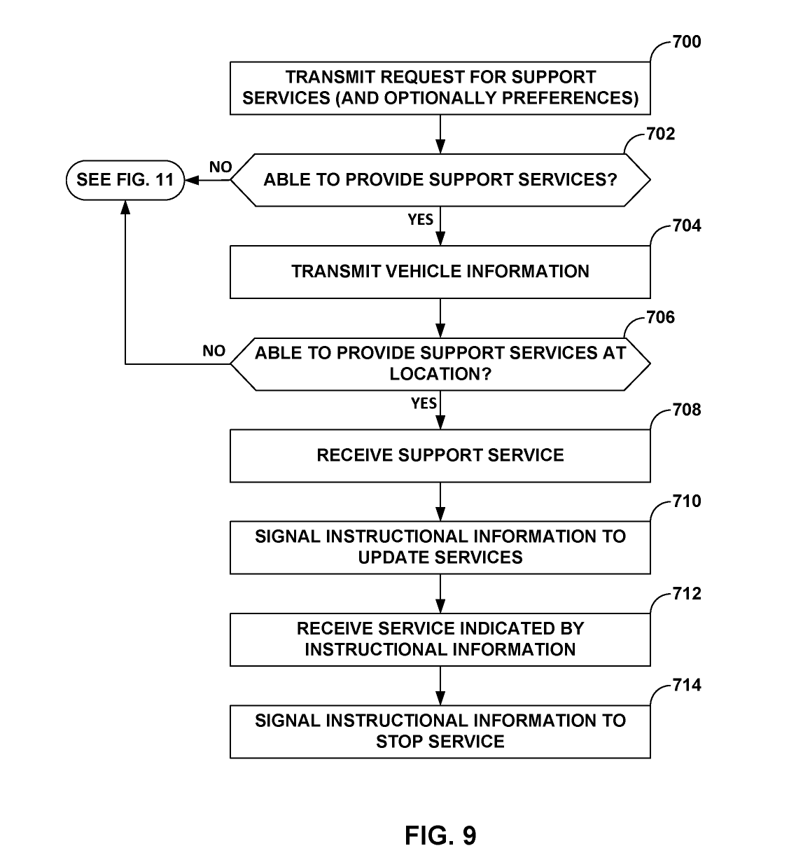

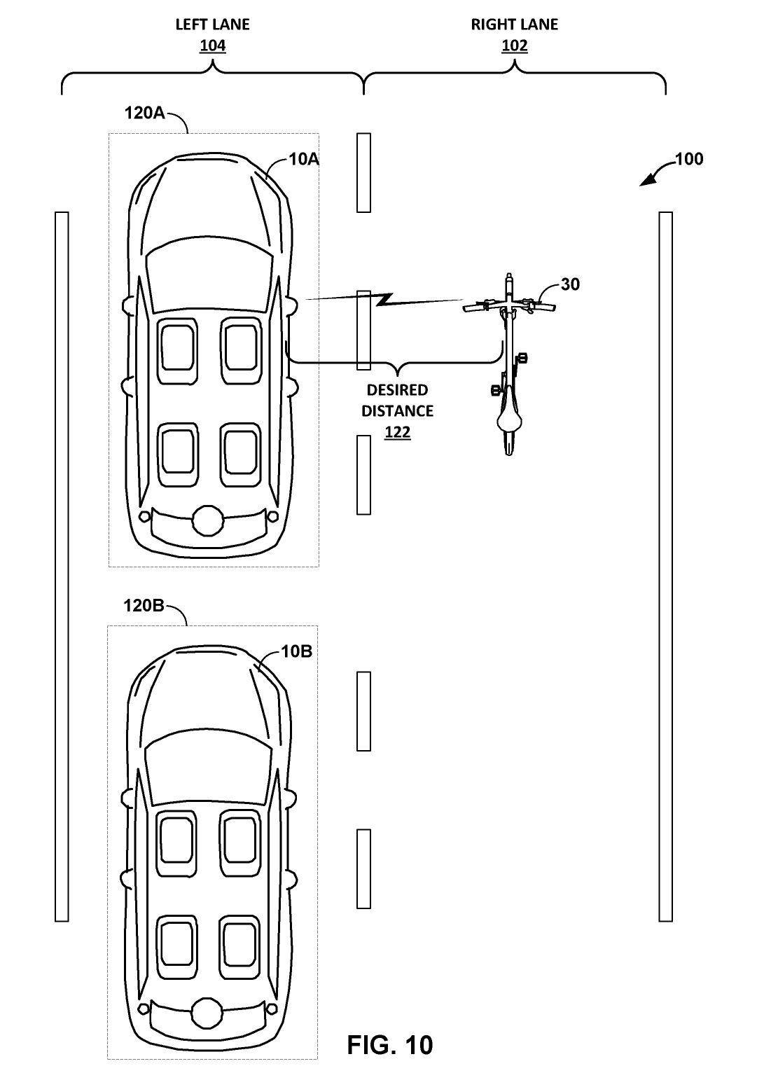

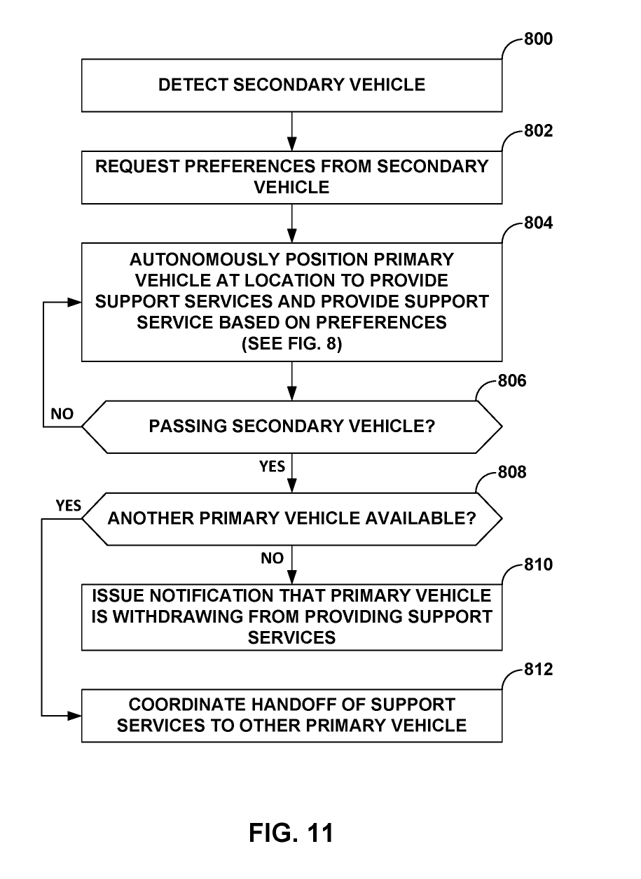

FIG. 8 is a flowchart illustrating example operation of primary vehicle 10 of FIG. 1 in performing various aspects of the support service techniques described in this disclosure. In the example of FIG. 8, processor 12 of primary vehicle 10 may initially receive, from secondary vehicle 30, a request that support services be provided for secondary vehicle 30, which may optionally include preferences 37 (600). The commuter may interface with secondary vehicle 30 via user interface 42 to enter the request or secondary vehicle 30 may be configured, via preferences 37, to issue the request upon commuter operating secondary vehicle 30.

Processor 12 of primary vehicle 10 may determine whether primary vehicle 10 is able to provide support services 17 (602). That is, processor 12 may determine whether primary vehicle 10 has the capability to provide support services 17 indicated by the request, and potentially in a manner that satisfies stated preferences 37. When not able to provide the requested support services (“NO” 602), processor 10 may respond to secondary vehicle 10 that support services cannot be provided, which may result in the process described below in more detail with respect to FIG. 11.

Assuming primary vehicle 10 is able to perform the support services (“YES” 602), processor 12 may receive vehicle information 45 from secondary vehicle 30 (604). Processor 12, autonomous control system 24, or possibly both processor 12 and autonomous control system 24 may determine a location at which to provide support services 17 based on vehicle information 45 and possibly preferences 37 (606).

Processor 12, autonomous control system 24, or possibly both processor 12 and autonomous control system 24 may determine whether the location is available (608). That is, primary vehicle 10 may determine whether the location is not occupied by another vehicle, whether road conditions permit primary vehicle 10 to reach the location, etc. When not available (“NO” 608), processor 10 may respond to secondary vehicle 10 that support services cannot be provided, which may result in the processes described below in more detail with respect to FIG. 11.

Assuming the determined location is available, autonomous control system 24 may autonomously position primary vehicle 10 at the location to provide services 17 in the manner described above (610). Processor 12 of primary vehicle 10 may determine whether instructional information has been received (612). When instructional information has not been received (“NO” 612), processor 12 may receive updated vehicle information 45, determine an updated location at which to provide the support services based on updated vehicle information 45 and preferences 37, and when the location is available, interface with autonomous control system 24 to autonomously position primary vehicle 10 at the location to provide services 17 (604-610).

When processor 12 of primary vehicle 10 determines that instructional information has been received (“YES” 612), processor 12 may determine whether the instructional information is indicative of a stop action (614). When the instructional information is not indicative of a stop action (“NO” 614), processor 12 may provide one of services 17 indicated by instructional information (616), and return to determine whether instructional information has been received (612). When the instructional information is indicative of a stop action (“YES” 614), processor 12 may interface with autonomous control system 24 to perform one of the stop actions described above with respect to the examples of FIGS. 7A-7C to allow the commuter to enter primary vehicle 10 (618).

FIG. 9 is a flowchart illustrating example operation of secondary vehicle 30 of FIG. 1 in performing various aspects of the support service techniques described in this disclosure. In the example of FIG. 9, processor 32 of secondary vehicle 30 may initially transmit, to primary vehicle 10, a request that support services be provided for secondary vehicle 30, which may optionally include preferences 37 (700). The commuter may interface with secondary vehicle 30 via user interface 42 to enter the request or secondary vehicle 30 may be configured, via preferences 37, to issue the request upon commuter operating secondary vehicle 30.

Processor 12 of primary vehicle 10 may determine whether primary vehicle 10 is able to provide support services 17. That is, processor 12 may determine whether primary vehicle 10 has the capability to provide support services 17 indicated by the request, and potentially in a manner that satisfies stated preferences 37. When not able to provide the requested support services, processor 10 may respond to secondary vehicle 10 that support services cannot be provided. As such, processor 32 of secondary vehicle may determine that primary vehicle 10 is not able to provide the support services (“NO” 702), which may result in the process described below in more detail with respect to FIG. 11.

Assuming primary vehicle 10 is able to perform the support services (“YES” 702), processor 32 may transmit vehicle information 45 from secondary vehicle 30 to primary vehicle 10 (704). Processor 12, autonomous control system 24, or possibly both processor 12 and autonomous control system 24 may determine a location at which to provide support services 17 based on vehicle information 45 and possibly preferences 37.

Processor 12, autonomous control system 24, or possibly both processor 12 and autonomous control system 24 may determine whether the location is available. That is, primary vehicle 10 may determine whether the location is not occupied by another vehicle, whether road conditions permit primary vehicle 10 to reach the location, etc. When not available, processor 10 may respond to secondary vehicle 10 that support services cannot be provided. As such, processor 32 may determine that support services cannot be provided at the location (“NO” 706), which may result in the processes described below in more detail with respect to FIG. 11.

Assuming the determined location is available, autonomous control system 24 may autonomously position primary vehicle 10 at the location to provide services 17 in the manner described above. In this respect, secondary vehicle 30 may receive support services (708). The commuter may next signal, via visual signals or directly via secondary vehicle 30, instructional information to update services (710). Secondary vehicle 30 may then receive the service indicated by the instructional information (712). The commuter may next signal, via visual signals or directly via secondary vehicle 30, instructional information to stop service (714), whereupon processor 12 may interface with autonomous control system 24 to perform one of the stop actions described above with respect to the examples of FIGS. 7A-7C to allow the commuter to enter primary vehicle 10.

FIG. 10 is a diagram illustrating an example in which two primary vehicles 10A and 10B cooperate to provide support services to secondary vehicle 30 in accordance with various aspects of the support service techniques described in this disclosure. Each of primary vehicles 10A and 10B may be similar to primary vehicle 10 shown in the example of FIG. 1, except that primary vehicles 10A and 10B may not be owned or accessible by the commuter. That is, above it was assumed that the commuter owned or otherwise had access to primary vehicle 10. In the example of FIG. 10, primary vehicles 10A and 10B may not be associated with the commuter, but rather function in a so-called “crowd sourced mode” to provide services (possibly for a fee) for secondary vehicle 30.

Primary vehicles 10A and 10B may detect or otherwise sense secondary vehicle 30 and temporarily provide support services for secondary vehicle 30. Primary vehicles 10A may be traveling at a rate of speed greater than secondary vehicle 30 and provide the support services until primary vehicle 10A passes by secondary vehicle 30. When passing secondary vehicle 30, primary vehicle 10A may coordinate hand off of the support services to primary vehicle 10B.

Primary vehicles 10A and 10B may provide the temporary support services based on the operating context, such as when relatively more dangerous situations occur. For example, primary vehicles 10A and 10B may provide the temporary support services when vehicles operates manually by an operator are in the vicinity of secondary vehicle 10, or when the commuter operating secondary vehicle 30 is about to cross a road, make a turn, change lanes, etc.

In this way, the at least one service may include a crowd-sourced protection service in which primary vehicles 10A and 10B coordinate to protect secondary vehicle 10 from other vehicles operating in a vicinity of the second vehicle.

FIG. 11 is a flowchart illustrating example operation of a primary vehicle 10A shown in FIG. 10 in performing crowd sourcing aspects of the support services techniques described in this disclosure. In the example of FIG. 11, primary vehicle 10A may initially detect secondary vehicle 30 (800). Autonomous control system 24 of primary vehicle 10A may detect secondary vehicle 30 via LIDAR or via other ways (e.g., image recognition, a wireless or optical beacon issued by secondary vehicle 30, etc.). Autonomous control system 24 may also determine current operating conditions to determine the extent to which secondary vehicle 30 is at risk of harm.

After detecting secondary vehicle 30 (and assuming sufficient risk of harm), autonomous control system 24 may interface with processor 12 such that processor 12 may request preferences 37 from secondary vehicle 30. Assuming secondary vehicle 30 responds with preferences 37, autonomous control system 24 may autonomously position primary vehicle 10 at a location to provide support services 17 and thereafter provide support services 17 based on preferences 37 (e.g., as described above with respect to FIG. 8) (804).

Autonomous control system 24 may determine whether or not primary vehicle 10 is passing secondary vehicle 30 such that primary vehicle 10 may no longer provide support services 17 (806). When not passing secondary vehicle 30 (“NO” 806), autonomous control system 24 may continue to autonomously position primary vehicle 10 at a location to provide support services 17 and thereafter provide support services 17 based on preferences 37 (e.g., as described above with respect to FIG. 8) (804).

When determined to be passing secondary vehicle 30 (“YES” 806), autonomous control system 24 may determine whether another primary vehicle (such as primary vehicle 10B shown in FIG. 10) is available (808). When no other primary vehicle is available (“NO” 808), autonomous control system 24 may interface with processor 12 such that processor 12 issues a notification that primary vehicle 10A is withdrawing from providing support services 17 and thereafter stops providing support services 17 for secondary vehicle 30 (810).

When other primary vehicle 10B is available (“YES” 808), primary vehicle 10A may coordinate handoff of support services to other primary vehicle 10B (812). Thereafter, primary vehicle 10B may perform the foregoing steps until primary vehicle 10B has determined primary vehicle 10B is passing secondary vehicle 10, at which point the search for another primary vehicle is performed or primary vehicle 10B issues the notification that primary vehicle 10B is withdrawing from providing support services 17 (802-812).

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processor” or “processing unit” has been used throughout this disclosure, it is understood that such processors or processing units may be implemented in hardware, software, firmware, or any combination thereof. For example, a processor may be implemented by programmable circuitry, fixed function circuitry, or both. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices,. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
receiving, by one or more processors of a first vehicle autonomously controlling operation of the first vehicle, vehicle information relating to a second vehicle, the second vehicle configured to be operated by an operator; and
autonomously controlling positioning, by the one or more processors of the first vehicle and based on the vehicle information, the first vehicle at a location relative to the second vehicle so as to perform at least one service for the second vehicle.

2. The method of claim 1, wherein the at least one service includes a protection service in which the first vehicle operates at the location relative to the second vehicle to protect the second vehicle from other vehicles operating in a vicinity of the second vehicle.

3. The method of claim 2, further comprising:
obtaining an operating context in which the second vehicle is being operated; and
determining, based on the determined operating context and the vehicle information, the location at which the first vehicle is to operate.

4. The method of claim 3,
wherein the second vehicle is a bicycle, and
wherein determining the location comprises determining, based on the determined operating context and the vehicle information, the location at which the first vehicle is to operate so as to emulate drafting conditions for the bicycle.

5. The method of claim 2, further comprising:
receiving preference information indicative of one or more preferences of the operator with regard to the autonomous operation of the first vehicle relative to the second vehicle in providing the protection service, wherein the preferences include one or more of a distance the first vehicle is to maintain relative to the second vehicle, a preferred location the second vehicle is to maintain relative to the second vehicle, or a type of barrier to deploy when performing the protection service; and
performing the protection service in accordance with at least the preference information.

6. The method of claim 5,
wherein the barrier comprises an extendable physical barrier, and
wherein performing the protection service comprises autonomously deploying the physical barrier from the first vehicle alongside, in front of, or behind the second vehicle.

7. The method of claim 1, wherein the at least one service includes an illumination service in which the first vehicle operates to illuminate an area near the second vehicle.

8. The method of claim 7,
wherein the second vehicle is a bicycle, and
wherein the illumination service includes an illumination service in which the first vehicle projects a virtual bike lane adjacent to the bicycle.

9. The method of claim 1, wherein the at least one service includes an alert service in which the first vehicle issues at least one of an audible or visual alert to other vehicles in a vicinity of the second vehicle with regard to current or upcoming operation of the second vehicle.

10. The method of claim 1,
wherein the vehicle information comprises first information, and
wherein the at least one service includes an information-providing service in which the first vehicle displays second information via one or more displays such that the operator is able to consume the second information.

11. The method of claim 1, further comprising:
obtaining, from at least one of the second vehicle or the operator of the second vehicle, instructional information indicative of an action to be performed by the first vehicle; and
performing the action indicated by the instructional information.

12. The method of claim 11, wherein obtaining the instructional information includes:
capturing image data of the operator of the second vehicle;
analyzing the image data to determine one or more visual signals given by the operator of the second vehicle representative of the action to be performed by the first vehicle; and
generating, based on the one or more visual signals, the instructional information indicative of the action.

13. A first vehicle comprising:
a memory configured to store vehicle information relating to a second vehicle, the second vehicle configured to be operated by an operator; and
one or more processors configured to:
autonomously control positioning, based on the vehicle information, the first vehicle at a location relative to the second vehicle; and
perform, after reaching the location, at least one service for the second vehicle.

14. The first vehicle of claim 13, wherein the at least one service includes a protection service in which the first vehicle operates at the location relative to the second vehicle to protect the second vehicle from other vehicles operating in a vicinity of the second vehicle.

15. The first vehicle of claim 14, wherein the one or more processors are further configured to:
obtain an operating context in which the second vehicle is being operated; and
determine, based on the determined operating context and the vehicle information, the location at which the first vehicle is to operate.

16. The first vehicle of claim 15,
wherein the second vehicle is a bicycle, and
wherein the one or more processors are configured to determine, based on the determined operating context and the vehicle information, the location at which the first vehicle is to operate so as to emulate drafting conditions for the bicycle.

17. The first vehicle of claim 14, wherein the one or more processors are further configured to:
receive preference information indicative of one or more preferences of the operator with regard to the autonomous operation of the first vehicle relative to the second vehicle in providing the protection service, wherein the preferences include one or more of a distance the first vehicle is to maintain relative to the second vehicle, a preferred location the second vehicle is to maintain relative to the second vehicle, or a type of barrier to deploy when performing the protection service; and
perform the protection service in accordance with at least the preference information.

18. The first vehicle of claim 17,
wherein the barrier comprises an extendable physical barrier, and
wherein the one or more processors are configured to autonomously deploy the physical barrier from the first vehicle alongside, in front of, or behind the second vehicle.

19. The first vehicle of claim 13, wherein the at least one service includes an illumination service in which the first vehicle operates to illuminate an area near the second vehicle.

20. The first vehicle of claim 19,
wherein the second vehicle is a bicycle, and
wherein the illumination service includes an illumination service in which the first vehicle projects a virtual bike lane adjacent to the bicycle.

21. The first vehicle of claim 13, wherein the at least one service includes an alert service in which the first vehicle issues at least one of an audible or visual alert to other vehicles in a vicinity of the second vehicle with regard to current or upcoming operation of the second vehicle.

22. The first vehicle of claim 13,
wherein the vehicle information comprises first information, and
wherein the at least one service includes an information-providing service in which the first vehicle displays second information via one or more displays such that the operator is able to consume the second information.

23. The first vehicle of claim 13, wherein the one or more processors are further configured to:
obtain, from at least one of the second vehicle or the operator of the second vehicle, instructional information indicative of an action to be performed by the first vehicle; and
perform the action indicated by the instructional information.

24. The first vehicle of claim 23, wherein the one or more processors are configured to:
capture image data of the operator of the second vehicle;
analyze the image data to determine one or more visual signals given by the operator of the second vehicle representative of the action to be performed by the first vehicle; and
generate, based on the one or more visual signals, the instructional information indicative of the action.

25. A method comprising:
determining, by one or more processors of a second vehicle, vehicle information relating to the second vehicle, the second vehicle configured to be operated by an operator; and
transmitting, by the one or more processors, the vehicle information to a first vehicle autonomously controlling operation of the first vehicle in response to the vehicle information such that the first vehicle is able to autonomously position the first vehicle at a location relative to the second vehicle that allows the first vehicle to perform at least one service for the second vehicle.

26. The method of claim 25, wherein the at least one service includes a protection service in which the first vehicle protects the second vehicle from other vehicles operating in a vicinity of the second vehicle.

27. The method of claim 25, wherein the at least one service includes a crowd-sourced protection service in which the first vehicle and a third vehicle coordinate to protect the second vehicle from other vehicles operating in a vicinity of the second vehicle.

28. A second vehicle comprising:
a processor configured to determine vehicle information relating to the second vehicle, the second vehicle configured to be operated by an operator;
a memory configured to store the vehicle information; and
an interface configured to transmit the vehicle information to a first vehicle autonomously controlling operation of the first vehicle such that the first vehicle is able to autonomously position the first vehicle at a location relative to the second vehicle that allows the first vehicle to perform at least one service for the second vehicle.

29. The second vehicle of claim 28, wherein the at least one service includes a protection service in which the first vehicle operates at the location relative to the second vehicle to protect the second vehicle from other vehicles operating in a vicinity of the second vehicle.

30. The second vehicle of claim 28, wherein the at least one service includes a crowd-sourced protection service in which the first vehicle and a third vehicle coordinate to protect the second vehicle from other vehicles operating in a vicinity of the second vehicle.
